(19) United States
(12) Patent Application Publication
(10) Pub. No.: US 2026/0362406 A1
(43) Pub. Date: Nov. 12, 2026

(54) CONFIGURATIONS OF A CELL WITH NON-CONTIGUOUS SPECTRUM

(71) Applicant: Samsung Electronics Co., Ltd., Gyeonggi-do (KR)

(72) Inventors: Mohamed Mokhtar Gaber Moursi AWADIN, San Diego, CA (US); Jung Hyun BAE, San Diego, CA (US); Youn Hyoung HEO, Sunnyvale, CA (US)

(21) Appl. No.: 19/660,722

(22) Filed: Apr. 28, 2026

Related U.S. Application Data
(60) Provisional application No. 63/802,192, filed on May 8, 2025.
(60) Provisional application No. 63/844,352, filed on Jul. 15, 2025.

(51) Int. Cl. H04W 72/0453; H04W 36/00

(52) U.S. Cl. CPC H04W 72/0453; H04W 36/00692

(57) ABSTRACT

A method for supporting non-contiguous spectrum operation includes transmitting, to a base station, capability information indicating support for non-contiguous spectrum within a serving cell; receiving, from the base station and based on the capability information, configuration information defining a bandwidth part (BWP) within the serving cell, the BWP including a plurality of non-contiguous spectrum chunks defined by respective frequency-domain parameters; and performing communication over the plurality of non-contiguous spectrum chunks as part of the BWP.

### CROSS-REFERENCE TO RELATED APPLICATIONS

This application claims the priority benefit under 35 U.S.C. § 119 (e) of U.S. Provisional Application No. 63/802,192, filed on May 8, 2025, and U.S. Provisional Application No. 63/844,352, filed on Jul. 15, 2025, the disclosures of which are incorporated by reference in their entirety as if fully set forth herein.

### TECHNICAL FIELD

The present disclosure relates generally to wireless communication systems and, more particularly, to techniques for supporting operation over non-contiguous spectrum.

### BACKGROUND

Wireless communication systems, such as New Radio (NR), support transmission over one or more carriers and bandwidth parts (BWPs). In some approaches, carrier aggregation (CA) is used to enable operation over non-contiguous spectrum by combining multiple component carriers (CCs), which may be configured as separate serving cells. Each CC may be associated with its own configuration parameters and may be scheduled independently or in coordination with other CCs.

In NR, configuration of a serving cell and associated carriers may be provided through radio resource control (RRC) signaling. Such configuration may include parameters defining frequency-domain location, bandwidth, subcarrier spacing, and other operational characteristics of a carrier or BWP.

FIG. 1 illustrates an example of how frequency-domain location of a carrier may be configured in NR systems. In NR, configuration of a serving cell may be provided through parameters such as ServingCellConfigCommon 101, which may include or be associated with a system information block (SIB) variant, such as ServingCellConfigCommonSIB. ServingCellConfigCommon 101 may include or reference downlink (DL) and/or uplink (UL) configuration parameters, such as DownlinkConfigCommon and/or UplinkConfigCommon 102, which may likewise have corresponding SIB-based representations.

The DownlinkConfigCommon and/or UplinkConfigCommon 102 parameters may include frequency-related configuration information, such as FrequencyInfoDL and/or FrequencyInfoUL 103, and may include SIB-based variants. The frequency-related configuration information may further include one or more entries of a SubcarrierSpacing-specific carrier list (SCS-SpecificCarrierList) 104 corresponding to supported subcarrier spacings (SCSs). Each entry of the SCS-SpecificCarrierList 104 may define a carrier configuration using SCS-SpecificCarrier parameters. For example, parameters such as offsetToCarrier, subcarrierSpacing, and carrierBandwidth may define a position and extent of a carrier in the frequency domain relative to a reference point. These parameters collectively describe how frequency-domain location and bandwidth of a carrier are conveyed in NR systems.

A serving cell identifier (ID) for a secondary cell (SCell) and a primary secondary cell (PSCell) may be assigned in CellGroupConfig information element (IE) for either CA or dual connectivity (DC) mode, via RRC parameter sCellIndex and servCellIndex, respectively. The value 0 is reserved for a primary cell (PCell) and is not configured, but predefined.

In legacy NR, a frequency domain location of DL/UL BWP may be provided through a resource indicator value (RIV) by locationAndBandwidth in BWP information element (IE). The RIV may indicate a start and a length of DL/UL BWP relative to a beginning of a CC containing this BWP and based on an SCS of the BWP. Specifically, the RIV may indicate a starting resource block (RBₛₜₐᵣₜ) and a length value

$${N}_{BWP}^{size} ,$$

where

$${N}_{BWP}^{size}$$

represents a size of a BWP in units of resource blocks. An index of a starting common resource block (CRB) may be determined as O_{carrier}+RBₛₜₐᵣₜ, where O_{carrier} represents an offset from a reference point to a first CRB of a carrier, provided by an offsetToCarrier parameter based on an SCS of the BWP.

In some examples, the parameters shown in FIG. 1 correspond to standardized RRC information elements defined in NR specifications and illustrate how frequency-domain location of a carrier is conveyed through hierarchical configuration structures. Such configurations may be used to define contiguous carrier regions or CCs. However, existing approaches based on contiguous carrier regions or aggregation of multiple CCs may introduce limitations. For example, configuring multiple non-contiguous frequency regions using separate CCs may increase signaling overhead, require additional control signaling, and impose scheduling constraints across carriers.

In addition, existing parameter structures may assume or favor contiguous frequency allocations or limited aggregation structures, which may reduce flexibility in utilizing fragmented or irregularly available spectrum. Representing multiple separated frequency regions may require repeated signaling of configuration parameters or use of multiple configuration elements, which can increase complexity and reduce efficiency.

In legacy NR, a user equipment (UE) can indicate to a next generation Node B (gNB) via capability signaling which bands it supports. For each supported band, the UE can indicate the supported SCSs and channel bandwidths. This is with the assumption that the channel is contiguous in the frequency domain. Table 1 illustrates an example of capability parameters indicating supported channel bandwidths (CBWs) for each frequency band and for each supported SCS. The term CBWs as used herein may correspond to standardized bandwidth definitions specified in 3GPP TS 38.101.

TABLE 1
Capability Signaling for Indicating Supported Channel Bandwidths

| | | | | | | |
|---|---|---|---|---|---|---|
| 2-1 | Maximum | 1) FR1 | channelBWs-DL | BandNR | UE | For FR1, all |
| | channel | channel | channelBWs-UL | | capability | the |
| | bandwidth | bandwidths | supportedBandwidthDL | FeatureSetDownlinkPerCC | signalling | bandwidths |
| | supported | in TS38.101- | channelBW-90 mhz | | shall follow | listed in |
| | in each | 1 Table | supportedBandwidthUL | FeatureSetUplinkPerCC | RP-172832 | TS38.101-1 |
| | band for | 5.3.5-1 | channelBW-90 mhz | | (Per-band | v15.0.0 |
| | DL and UL | 2) FR2 | | | capability | Table 5.3.5- |
| | separately | channel | | | signalling, | 1 for each |
| | and for | bandwidths | | | separately | band shall |
| | each SCS | in TS38.101- | | | for DL and | be |
| | that UE | 2 Table | | | UL and for | mandatory |
| | supports | 5.3.5-1 | | | each SCS) | with a single |
| | within a | | | | Whether a | CC. The |
| | single CC | | | | bandwidth | bandwidths |
| | | | | | newly | listed in the |
| | | | | | introduced | slide #3 of |
| | | | | | in future is | R4-1805985 |
| | | | | | mandatory | are |
| | | | | | for UE shall | mandatory |
| | | | | | be | with a single |
| | | | | | discussed | CC. 90 MHz |
| | | | | | case by | is optional |
| | | | | | case. | for n41, |
| | | | | | | n77, n78. |
| | | | | | | For FR2, |
| | | | | | | the set of |
| | | | | | | mandatory |
| | | | | | | CBW is 50, |
| | | | | | | 100, 200 |
| | | | | | | MHz. |

The capability parameters shown in Table 1 may indicate maximum supported bandwidths for DL and UL, separately for each frequency band and for each SCS. The parameters may be based on standardized bandwidth (BW) definitions, such as those specified in 3GPP TS 38.101-1 and TS 38.101-2, and may include capability signaling elements such as channelBWs-DL and channelBWs-UL.

A UE may support one UE-specific RRC DL BWP per carrier and one UE-specific RRC UL BWP per carrier. Optionally, via capability signaling (e.g., bwp-SameNumerology), the UE may support multiple UE-specific RRC DL BWPs per carrier and multiple UE-specific RRC UL BWPs per carrier, provided that the BWPs share the same numerology (e.g., the same SCS). Furthermore, via capability signaling (e.g., bwp-DiffNumerology), the UE may indicate support for multiple UE-specific RRC DL BWPs per carrier and multiple UE-specific RRC UL BWPs per carrier having different numerologies (e.g., different SCSs).

For CA, based on a basic CA feature group, a UE supporting CA may support up to 16 CCs for DL and up to 16 CCs for UL. Moreover, there may be separate frequency gaps (FGs), e.g., crossCarrierScheduling-SameSCS and crossCarrierScheduling-OtherSCS, to indicate whether cross carrier scheduling is restricted to the same SCS (scheduling cell and scheduled cell have the same SCS), or different SCSs.

In Frequency Range 1 (FR1), for the case of non-contiguous intra-band CA, a UE can indicate, via intraBandFreqSeparationUL-AggBW-GapBW-r16, a UL frequency separation class between a lower edge of a lowest CC and an upper edge of a highest CC of Intra-band UL non-contiguous CA when signaling is absent for dualPA-Architecture IE. Table 2 shows currently-supported spans.

TABLE 2
NR Intra-Band Non-Contiguous UL
CA Frequency Separation Classes

| NR NC UL CA frequency | Maximum allowed |
|---|---|
| separation class | frequency separation |
| I | 100 MHz |
| II | 200 MHz |
| III | [600 MHz] |

In Frequency Range 2 (FR2) only, for the case of non-contiguous intra-band CA, a UE can indicate, via intraBandFreqSeparationDL and intraBandFreqSeparationUL, a maximum supported span between a lower edge of a lowest component carrier and an upper edge of a highest component carrier that the UE can support per band in DL or UL, respectively, in non-contiguous intra-band operation. Table 3 illustrates currently-supported spans.

TABLE 3
Frequency Separation Classes for Non-
Contiguous Intra-Band Operation

| Frequency separation class | Frequency separation (Fs) |
|---|---|
| I | Fs ≤ 800 MHz |
| II | Fs ≤ 1200 MHz |
| III | Fs ≤ 1400 MHz |

For FR1 and FR2, in the case of contiguous intra-band CA, a UE can indicate an aggregated transmission bandwidth configuration and a maximum number of CCs supported by the UE. Table 4 shows supported CA bandwidth classes for FRI, and Table 5 shows supported CA bandwidth classes for FR2.

TABLE 4
CA Bandwidth Classes for FR1

| NR CA | | Number of | Fall- |
|---|---|---|---|
| bandwidth | | contiguous | back |
| class | Aggregated channel bandwidth | CC | group |
| A | BW_{Channel} ≤ BW_{Channel, max} | 1 | 1, 2 |
| B | 20 MHz ≤ BW_{Channel}_{_{—}}_{CA} ≤ 100 MHz | 2 | 2 |
| C | 100 MHz < BW_{Channel}_{_{—}}_{CA} ≤ 2 × | 2 | 1 |
| | BW_{Channel, max} | | |
| D | 200 MHz < BW_{Channel}_{_{—}}_{CA} ≤ 3 × | 3 | |
| | BW_{Channel, max} | | |
| E | 300 MHz < BW_{Channel}_{_{—}}_{CA} ≤ 4 × | 4 | |
| | BW_{Channel, max} | | |
| G | 100 MHz < BW_{Channel}_{_{—}}_{CA} ≤ 150 MHz | 3 | 2 |
| H | 150 MHz < BW_{Channel}_{_{—}}_{CA} ≤ 200 MHz | 4 | |
| I | 200 MHz < BW_{Channel}_{_{—}}_{CA} ≤ 250 MHz | 5 | |
| J | 250 MHz < BW_{Channel}_{_{—}}_{CA} ≤ 300 MHz | 6 | |
| K | 300 MHz < BW_{Channel}_{_{—}}_{CA} ≤ 350 MHz | 7 | |
| L | 350 MHz < BW_{Channel}_{_{—}}_{CA} ≤ 400 MHz | 8 | |

NOTE 1:
BW_{Channel, max} is maximum channel bandwidth supported among all bands in a release
NOTE 2:
It is mandatory for a UE to be able to fallback to lower order NR CA bandwidth class configuration within a fallback group. It is not mandatory for a UE to be able to fallback to lower order NR CA bandwidth class configuration that belong to a different fallback group

TABLE 5
CA Bandwidth Classes for FR2

| NR CA | | Number of | Fall- |
|---|---|---|---|
| bandwidth | | contiguous | back |
| class | Aggregated channel bandwidth | CC | group |
| A | BW_{Channel} ≤ 400 MHz | 1 | 1, 2, |
| | | | 3, 4 |
| B | 400 MHz < BW_{Channel}_{_{—}}_{CA} ≤ 800 MHz | 2 | 1 |
| C | 800 MHz < BW_{Channel}_{_{—}}_{CA} ≤ 1200 MHz | 3 | |
| D | 200 MHz < BW_{Channel}_{_{—}}_{CA} ≤ 400 MHz | 2 | 2 |
| E | 400 MHz < BW_{Channel}_{_{—}}_{CA} ≤ 600 MHz | 3 | |
| F | 600 MHz < BW_{Channel}_{_{—}}_{CA} ≤ 800 MHz | 4 | |
| G | 100 MHz < BW_{Channel}_{_{—}}_{CA} ≤ 200 MHz | 2 | 3 |
| H | 200 MHz < BW_{Channel}_{_{—}}_{CA} ≤ 300 MHz | 3 | |
| I | 300 MHz < BW_{Channel}_{_{—}}_{CA} ≤ 400 MHz | 4 | |
| J | 400 MHz < BW_{Channel}_{_{—}}_{CA} ≤ 500 MHz | 5 | |
| K | 500 MHz < BW_{Channel}_{_{—}}_{CA} ≤ 600 MHz | 6 | |
| L | 600 MHz < BW_{Channel}_{_{—}}_{CA} ≤ 700 MHz | 7 | |
| M | 700 MHz < BW_{Channel}_{_{—}}_{CA} ≤ 800 MHz | 8 | |
| O | 100 MHz ≤ BW_{Channel}_{_{—}}_{CA} ≤ 200 MHz | 2 | 4 |
| P | 150 MHz ≤ BW_{Channel}_{_{—}}_{CA} ≤ 300 MHz | 3 | |
| Q | 200 MHz ≤ BW_{Channel}_{_{—}}_{CA} ≤ 400 MHz | 4 | |

NOTE 1:
Maximum supported component carrier bandwidths for fallback groups 1, 2, 3 and 4 are 400 MHz, 200 MHz, 100 MHz and 100 MHz respectively except for CA bandwidth class A.
NOTE 2:
It is mandatory for a UE to be able to fallback to lower order CA bandwidth class configuration within a fallback group. It is not mandatory for a UE to be able to fallback to lower order CA bandwidth class configuration that belong to a different fallback group.

With reference to Tables 4, and 5, similar procedures may be used for indicating a maximum number of supported non-contiguous CCs for inter-band CA and intra-band CA. For the former, non-contiguous inter-band CA, a UE can indicate a number of bands that can be simultaneously handled as part of an RRC parameter bandList. Therefore, the maximum number of supported non-contiguous CCs for inter-band CA may be implicitly determined based on the number of bands in a supported band list of a band combination.

For the latter, non-contiguous intra-band CA, the RRC parameter bandList may be used to indicated the maximum number of supported non-contiguous CCs for intra-band CA. Specifically, a UE may indicate support of the same (the identical) band multiple times. For example, the UE may indicate that it supports band n1 two times. For each configuration instance of BandParameters corresponding to the same band, the UE may indicate the corresponding ca-BandwidthClassDL-NR/ca-BandwidthClassUL-NR. This implicitly means that the UE may support multiple non-contiguous CCs in the same band n1, i.e., intra-band CA.

| | |
|---|---|
| BandCombination :: = | SEQUENCE { |
| bandList | SEQUENCE (SIZE |

(1..maxSimultaneousBands)) OF BandParameters,

| | |
|---|---|
| featureSetCombination | FeatureSetCombinationId, |
| ca-ParametersEUTRA | CA- |
| ParametersEUTRA | OPTIONAL, |
| ca-ParametersNR | CA- |
| ParametersNR | OPTIONAL, |
| mrdc-Parameters | MRDC- |
| Parameters | OPTIONAL, |
| supportedBandwidthCombinationSet | BIT STRING (SIZE |
| (1..32)) | OPTIONAL, |
| powerClass-v1530 | ENUMERATED |
| {pc2} | OPTIONAL |

}

| | |
|---|---|
| BandParameters ::= | CHOICE { |
| eutra | SEQUENCE { |
| bandEUTRA | FreqBandIndicatorEUTRA, |
| ca-BandwidthClassDL-EUTRA | CA-BandwidthClassEUTRA |

OPTIONAL,

| | |
|---|---|
| ca-BandwidthClassUL-EUTRA | CA-BandwidthClassEUTRA |

OPTIONAL
},

| | |
|---|---|
| nr | SEQUENCE { |
| bandNR | FreqBandIndicatorNR, |
| ca-BandwidthClassDL-NR | CA-BandwidthClassNR |

OPTIONAL,

| | |
|---|---|
| ca-BandwidthClassUL-NR | CA-BandwidthClassNR |

OPTIONAL
}
}

Accordingly, there is a need for improved mechanisms to represent and manage non-contiguous spectrum configurations in a manner that supports flexible spectrum usage while reducing signaling overhead and maintaining compatibility with existing frameworks.

### SUMMARY

In wireless communication systems such as New Radio (NR), carrier aggregation (CA) may be used to support non-contiguous spectrum. In some approaches, each portion of spectrum may be treated as a separate component carrier (CC) corresponding to a separate serving cell. This approach may increase signaling overhead and impose scheduling constraints. To overcome these issues, systems, methods, and computer-readable media are described for configuring a serving cell to operate using multiple non-contiguous spectrum chunks. As used herein, a “spectrum chunk” refers to a contiguous set of frequency-domain resources separated in frequency from other such sets.

In an embodiment, a method performed by a user equipment (UE) comprises transmitting, to a base station, capability information indicating support for non-contiguous spectrum within a serving cell; receiving, from the base station and based on the capability information, configuration information defining a bandwidth part (BWP) within the serving cell, the BWP including a plurality of non-contiguous spectrum chunks defined by respective frequency-domain parameters; and performing communication over the plurality of non-contiguous spectrum chunks as part of the BWP.

In an embodiment, a UE comprises a communication module and a processor, wherein the processor is configured to transmit, to a base station, capability information indicating support for non-contiguous spectrum within a serving cell; receive, from the base station and based on the capability information, configuration information defining a bandwidth part (BWP) within the serving cell, the BWP including a plurality of non-contiguous spectrum chunks defined by respective frequency-domain parameters; and perform communication over the plurality of non-contiguous spectrum chunks as part of the BWP.

In an embodiment, a base station comprises a communication module and a processor, wherein the processor is configured to wherein the processor is configured to receive, from a UE, capability information indicating support for operation over non-contiguous spectrum within a serving cell; transmit, to the UE and based on the capability information, configuration information defining a BWP within the serving cell, the BWP including a plurality of non-contiguous spectrum chunks defined by respective frequency-domain parameters; and coordinate communication over the plurality of non-contiguous spectrum chunks.

In an embodiment, a non-transitory computer-readable medium stores instructions that, when executed by a processor of a UE, cause the UE to transmit, to a base station, capability information indicating support for operation over non-contiguous spectrum within a serving cell; receive, from the base station and based on the capability information, configuration information defining a BWP within the serving cell including a plurality of non-contiguous spectrum chunks defined by respective frequency-domain parameters; and perform communication over the plurality of non-contiguous spectrum chunks as part of the BWP.

In an embodiment, capability signaling indicating support for non-contiguous spectrum operation may be transmitted by the UE and/or configured by a network node. The capability signaling may include parameters indicating a maximum number of supported chunks, a maximum frequency span between a lowest-frequency chunk and a highest-frequency chunk, and constraints on chunk size or spacing. In some embodiments, the capability signaling may further indicate whether chunks are required to be contiguous within a given range or may be arbitrarily separated. Such capability signaling may be used by the network to determine feasible configurations for the serving cell.

In an embodiment, capability signaling defined for CA may be used to indicate support for multiple non-contiguous spectrum chunks within a single serving cell. For example, a band combination parameter may be used to indicate multiple chunks rather than multiple serving cells. In some embodiments, repeated indications of a same band may correspond to multiple non-contiguous chunks within that band. This approach enables reuse of existing signaling frameworks while supporting non-contiguous spectrum operation within a single cell. Accordingly, the described approach reduces signaling overhead and improves resource utilization in wireless communication systems.

In some embodiments, a single serving cell may include a BWP comprising multiple non-contiguous spectrum chunks distributed across different frequency bands. For example, a serving cell may include a first chunk in a first frequency band, a second chunk in a second frequency band, and a third chunk in a third frequency band, while being configured and signaled as part of a single serving cell. Such configurations may be supported through reuse of carrier aggregation capability signaling, including interpretation of band combination parameters to represent multiple chunks rather than multiple serving cells.

In an embodiment, a BWP comprises multiple non-contiguous spectrum chunks, each defined by a respective location parameter such as a resource indication value (RIV) or offset. The plurality of chunks may be configured to operate as a single logical BWP for purposes of scheduling and resource allocation. In a further embodiment, the chunks may have equal or unequal sizes and may be dynamically reconfigured.

In an embodiment, control mechanisms are provided for managing the plurality of non-contiguous spectrum chunks. For example, one or more inactivity timers may be maintained for each of one or more respective chunks, and a chunk may be deactivated upon expiration of a corresponding inactivity timer. In a further embodiment, a subset of chunks may remain continuously active, while other chunks are selectively activated based on traffic conditions. Activation of a chunk may be triggered by control signaling received on another chunk.

In an embodiment, a serving cell is associated with multiple CCs corresponding to the plurality of non-contiguous spectrum chunks. The CCs may share common configuration parameters while enabling operation across fragmented spectrum. In a further embodiment, each of a plurality of CCs may have an associated BWP, and multiple BWPs across different CCs may be active concurrently.

The subject matter disclosed herein may provide a number of technical advantages, including a reduction in signaling overhead and improved scheduling flexibility for non-contiguous spectrum operation. For example, by configuring multiple non-contiguous spectrum chunks within a single serving cell, separate cell-level configuration signaling for each spectrum portion may be avoided. In addition, scheduling constraints associated with some CA frameworks may be reduced, enabling more efficient allocation of resources across the non-contiguous spectrum chunks. Further, the use of a single BWP spanning multiple non-contiguous chunks may facilitate more flexible hybrid automatic repeat request (HARQ) operation and resource sharing. Power consumption may also be improved through mechanisms such as chunk-specific activation and deactivation, including the use of inactivity timers. Moreover, the disclosed approaches may reduce implementation complexity by avoiding strict dependencies between CCs while still enabling operation across fragmented spectrum.

### BRIEF DESCRIPTION OF THE DRAWINGS

In the following section, the aspects of the subject matter disclosed herein will be described with reference to exemplary embodiments illustrated in the figures, in which:

FIG. 1 illustrates an example radio resource control (RRC) configuration for associating a serving cell with one or more component carriers (CCs).

FIG. 2 illustrates an example of non-contiguous spectrum chunks and an associated frequency span, according to the subject matter disclosed herein.

FIG. 3 illustrates frequency locations of multiple chunks of a bandwidth part (BWP) with non-contiguous spectrum, according to the subject matter disclosed herein.

FIG. 4 illustrates frequency locations of multiple chunks having equal sizes within a BWP with non-contiguous spectrum, according to the subject matter disclosed herein.

FIG. 5 illustrates alignment of a center of an aggregated spectrum of a downlink (DL) BWP and an uplink (UL) BWP, according to the subject matter disclosed herein.

FIG. 6 illustrates pair-wise alignment across chunks of a DL BWP and an UL BWP, according to the subject matter disclosed herein.

FIG. 7 illustrates alignment based on a frequency edge of a DL BWP and an UL BWP, according to the subject matter disclosed herein.

FIG. 8 illustrates use of separate inactivity timers for respective chunks of a non-contiguous BWP, according to the subject matter disclosed herein.

FIG. 9 illustrates use of a shared inactivity timer applied sequentially across chunks of a non-contiguous BWP, according to the subject matter disclosed herein.

FIG. 10 illustrates reactivation of a chunk of a non-contiguous BWP while another chunk remains active, according to the subject matter disclosed herein.

FIG. 11 illustrates configuration of non-contiguous spectrum as a single serving cell including multiple CCs, according to the subject matter disclosed herein.

FIG. 12 illustrates configuration of BWPs across multiple CCs within a single serving cell, according to the subject matter disclosed herein.

FIG. 13 illustrates configuration of non-contiguous BWPs across multiple cells while maintaining a logical single serving cell abstraction, according to the subject matter disclosed herein.

FIG. 14 illustrates an electronic device in a network environment configured to support non-contiguous spectrum operation, according to the subject matter disclosed herein.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

In wireless communication systems such as NR, a UE may indicate, via capability signaling, supported frequency bands, SCSs, and channel bandwidths. Conventional configurations generally assume that each carrier occupies a contiguous portion of spectrum in the frequency domain. Similarly, CA enables operation across multiple CCs, where each CC is associated with a respective serving cell.

In existing CA and BWP configurations, resource allocation may be based on contiguous frequency regions within a carrier or across a limited number of carriers. Such approaches may assume that a BWP occupies a continuous frequency span or that aggregation occurs across discrete carriers with well-defined boundaries. These assumptions can limit flexibility in utilizing fragmented or irregularly available spectrum resources, particularly in scenarios where spectrum availability is non-contiguous or dynamically allocated.

Existing configurations for representing frequency-domain resources and associated parameters may introduce signaling overhead, especially when attempting to describe multiple separated frequency regions using existing parameter sets. For example, representing non-contiguous allocations may require multiple configuration elements or repeated signaling of frequency location and bandwidth parameters. This can increase control signaling complexity and reduce efficiency, particularly when supporting dynamic or fine-grained spectrum usage across multiple chunks within a single BWP or cell. Accordingly, there is a need for improved mechanisms to represent and manage non-contiguous spectrum configurations in a manner that balances flexibility and signaling efficiency.

As used herein, a “spectrum chunk” (or simply “chunk”) may refer to a contiguous set of frequency-domain resources within a BWP or serving cell, such as a set of physical resource blocks (PRBs), resource elements (REs), or subcarriers, that is separated in frequency from other such sets. A spectrum chunk may correspond to a frequency region defined by configuration parameters, such as an RIV, an offset parameter (e.g., offsetToCarrier), a bandwidth parameter (e.g., carrierBandwidth), or other frequency-domain descriptors.

In some embodiments, a plurality of spectrum chunks may collectively form a non-contiguous BWP or a non-contiguous frequency allocation within a single serving cell. The spectrum chunks may be separated by one or more gaps in the frequency domain, where no resources of the BWP are allocated. The spectrum chunks may have equal or unequal bandwidths, may be located within a same frequency band or across different frequency bands, and may be statically or dynamically configured.

In some embodiments, a spectrum chunk may be associated with one or more configuration parameters, including time-domain parameters, frequency-domain parameters, or reference signal configurations. In some embodiments, a spectrum chunk may be treated as a logical subdivision of a BWP for purposes of configuration, scheduling, or signaling, without necessarily corresponding to a separately configured CC.

The term “spectrum chunks” may be used for convenience to describe non-contiguous frequency-domain portions of a BWP or serving cell and does not imply any specific standardized terminology. Other terms, such as “frequency segments,” “sub-bands,” or “resource regions,” may be used interchangeably in some contexts.

In NR, a serving cell may be associated with one or more CCs, and each CC may be configured with one or more BWPs. A BWP typically occupies a contiguous set of physical resource blocks (PRBs) within a CC, and its location may be defined relative to the CC using parameters such as offsets and bandwidth indicators. Accordingly, both CCs and BWPs are generally configured as contiguous frequency regions.

However, in many deployment scenarios, available spectrum for an operator may be fragmented or non-contiguous. Some approaches, such as CA, treat each non-contiguous portion of spectrum as a separate CC and often as a separate serving cell. This approach may increase signaling overhead, introduce additional configuration complexity, and impose scheduling constraints across multiple carriers or cells.

Accordingly, there is a need for techniques that enable operation over non-contiguous spectrum without requiring separate serving cells or excessive signaling overhead. In particular, it may be desirable to support configurations in which multiple non-contiguous spectrum portions are associated with a single serving cell and are managed in a more unified manner.

In some embodiments, capability signaling may be used to indicate support for operation over multiple non-contiguous spectrum chunks. Such capability signaling may include parameters indicating, for example, a number of supported chunks, a frequency span across the chunks, bandwidths of the chunks, or spacing between the chunks. In some embodiments, existing capability signaling defined for CA may be interpreted or reused to represent support for multiple non-contiguous spectrum chunks within a single serving cell.

In some embodiments, a BWP may include multiple non-contiguous spectrum chunks. Each chunk may be defined by a respective frequency-domain location parameter, and the plurality of chunks may be configured to operate as a single logical BWP for purposes of communication, scheduling, or resource allocation.

In some embodiments, control mechanisms may be provided for managing the plurality of non-contiguous spectrum chunks. For example, respective chunks may be activated or deactivated based on control conditions, such as inactivity timers, traffic conditions, or control signaling. In some cases, a subset of chunks may remain active while other chunks are dynamically activated or deactivated.

In some embodiments, a serving cell may be associated with multiple CCs corresponding to respective non-contiguous spectrum chunks. The CCs may share configuration or control relationships, enabling operation across fragmented spectrum while maintaining a unified serving cell abstraction.

As described herein, various embodiments enable operation over non-contiguous spectrum within a single serving cell. For example, multiple non-contiguous spectrum chunks may be associated with a single BWP and/or a single serving cell, thereby reducing signaling overhead and improving flexibility relative to some CA approaches.

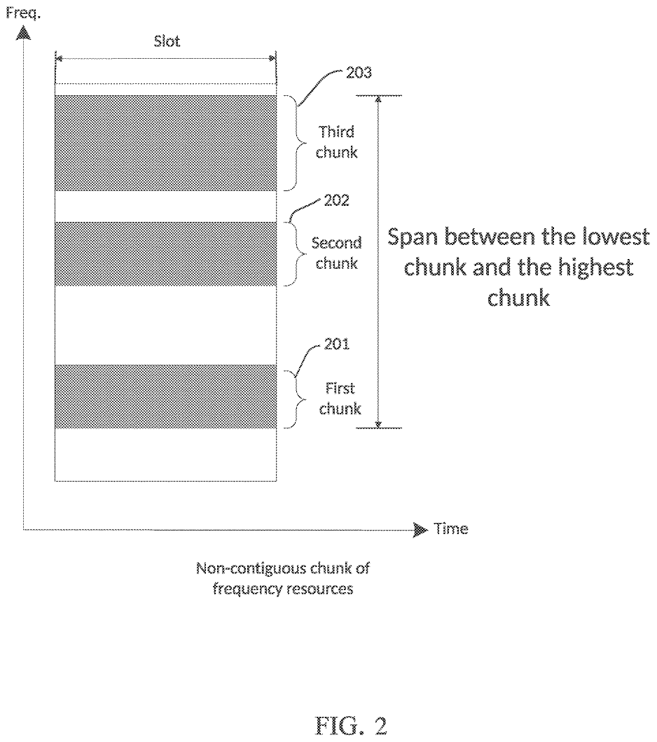

FIG. 2 illustrates an example of non-contiguous spectrum that may be utilized by a UE according to the subject matter disclosed herein. As shown in FIG. 2, a first chunk 201, a second chunk 202, and a third chunk 203 are separated in the frequency domain. The chunks may correspond to portions of a BWP or other resource groupings defined within a serving cell. For example, a “spectrum chunk” (or simply “chunk”) may refer to a contiguous set of frequency-domain resources within a BWP or serving cell, such as a set of PRBs, REs, or subcarriers, that is separated in frequency from other such sets. A spectrum chunk may correspond to a frequency region defined by configuration parameters, such as an RIV, an offset parameter (e.g., offsetToCarrier), a bandwidth parameter (e.g., carrierBandwidth), or other frequency-domain descriptors. Depending on the deployed framework, each chunk of resources may be a set of resources in a BWP, each chunk may be an active BWP, or each chunk may be a CC.

In some embodiments, the UE may indicate, via capability signaling, whether it supports contiguous spectrum, non-contiguous spectrum, or both. Separate capability indications may be provided for DL reception and UL transmission.

In some embodiments, the UE may indicate support for operation over multiple non-contiguous spectrum chunks and may provide capability parameters defining constraints on such configurations. For example, the UE may indicate a maximum and/or minimum span between a lowest-frequency chunk (e.g., the first chunk 201) and a highest-frequency chunk (e.g., the third chunk 203), where the span is defined based on a difference between a lowest resource block (RB) or RE of the lowest-frequency chunk and a highest RB or RE of the highest-frequency chunk. In another example, the UE may indicate a minimum/maximum number of RBs or REs between the highest RB or RE of a chunk and the lowest RB or RE of the next chunk. Also, the UE may indicate whether the spacing between any two contiguous chunks should be the same or can vary. These may be indicated per UE, per BWP, per CC, per band or band combination. Additionally, the UE may indicate the total number of aggregated RBs across all the chunks, excluding the gaps between them.

In some embodiments, the UE may indicate a maximum number of supported chunks within a serving cell, BWP, CC, band, or band combination. Also, the UE may indicate the maximum supported number of cells that may comprise non-contiguous spectrum chunks. The UE may further indicate whether chunks are required to have equal sizes or may have variable sizes, as well as minimum and/or maximum supported sizes of individual chunks.

In some embodiments, the UE may indicate constraints on spacing between adjacent chunks. For example, spacing constraints may include minimum and/or maximum frequency gaps between consecutive chunks, where a gap corresponds to a frequency-domain region between adjacent chunks in which no RBs or REs are allocated. The UE may further indicate whether spacing between chunks is fixed or variable.

In some embodiments, the UE may indicate whether chunk configurations are subject to intra-band or inter-band constraints, and may indicate grouping rules, separation thresholds, or aggregation classes associated with chunk configurations.

In some embodiments, capability signaling defined for CA may be reused or extended to indicate support for non-contiguous spectrum chunks within a single serving cell. For example, parameters associated with band combinations, bandwidth classes, or supported CCs may be interpreted to indicate properties of non-contiguous spectrum chunks, including number of supported chunks, supported spans, aggregated bandwidth (e.g., total RBs across all chunks, and/or constraints on chunk size or spacing.

In some embodiments, support for non-contiguous spectrum may be accounted for within capability budgets associated with BWPs or CCs. For example, each chunk may contribute a fractional or full count toward a supported number of BWPs or CCs based on a scaling parameter. In some embodiments, a scaling factor may be selected from a predefined set to represent a relative impact of each chunk on UE capability limits, thereby enabling flexible tradeoffs between contiguous and non-contiguous configurations.

In some embodiments, capability signaling may further define interactions between chunk-related limits and BWP or CC limits. For example, a UE may indicate a maximum number of supported BWPs, a maximum number of supported chunks, and a joint constraint on a combined number of BWPs and chunks. This enables flexible configuration in which, for example, multiple contiguous BWPs or fewer BWPs with multiple non-contiguous chunks may be supported.

In some embodiments, for a UE supporting CA, each chunk may be counted toward limits associated with a number of supported CCs or bandwidth classes. For example, configuration of multiple chunks within a band may reduce a number of additional contiguous CCs that may be configured within that band.

In some embodiments, a plurality of chunks may be configured within a single serving cell and/or a single BWP, thereby enabling operation over non-contiguous spectrum without requiring separate serving cells. Such configurations may reduce signaling overhead and improve flexibility relative to CA approaches.

In some embodiments, a scaling factor (denoted herein as a or B) may be used to represent a relative contribution of each spectrum chunk toward a capability limit, such as a BWP budget or a CC budget. The scaling factor may be predefined or indicated via capability signaling, and may take values such as 0, 0.5, or 1, depending on an implementation or configuration.

In some embodiments, supporting a single cell with non-contiguous spectrum may be counted toward the CA and/or BWP budget. For example, if a UE indicates that it supports two or four BWPs with the same or different numerologies, then each chunk of non-contiguous spectrum may be counted as a value determined based on a scaling factor β toward the CA/BWP budget limit. The value of β may be predefined, for example, specified in a standard, or provided to a next generation Node B (gNB) via capability signaling. The value of β may be from the set {0, 0.5, 1}, where 0 may indicate no additional complexity for handling multiple chunks. Specifically, in response to β=0, if the UE supports a BWP consists of three non-contiguous chunks, then this BWP is just counted as one towards the BWP budget. If the UE can support total 3 chunks per cell (across BWPs), with β=0, the gNB can still configure 3 BWPs and each BWP can be configured with 3 different non-contiguous chunks. In response to β=0.5, if the UE supports a BWP consists of three non-contiguous chunks, then this BWP can be counted as 1.5 (0.5*3 (#of chunks)) towards the BWP budget.

In some embodiments, in response to β=1, if the UE supports a BWP comprising three non-contiguous chunks, then this BWP is counted as 3 (1*3 (#of chunks)) towards the BWP budget. If the UE can support total 3 chunks per cell (across BWPs), with β=1, the gNB can configure only 1 BWPs with 3 different non-contiguous chunks. Additionally, for a UE supporting CA, there may be a number of CCs that the UE may support. In situations where the UE supports non-contiguous spectrum, each chunk may be counted as n towards this limit. The value of n may be determined in a similar approach as described earlier for B. For example, each chunk may be counted as a one CC toward the budget on the number of CCs to be supported.

In a further embodiment, a UE may indicate a number of supported CCs within contiguous intra-band CA, or within each sub-blocks in case of non-contiguous intra-band CA, via ca-BandwidthClassDL-NR and ca-BandwidthClassUL-NR. When the UE supports a single cell comprising non-contiguous spectrum, the number of configured chunks may be counted as e towards these limits. The value of ∈ may be determined using the same approach described earlier in conjunction with β. For example, if within a particular band, the maximum number of supported contiguous CC is indicated to be 5 and the UE is configured with a cell with 3 chunks, then the number of available CCs to be configured within this band is 2.

As used herein, an “aggregated spectrum” may refer to a frequency-domain span extending from a lowest-frequency edge of a lowest-frequency chunk to a highest-frequency edge of a highest-frequency chunk. In some embodiments, the aggregated spectrum includes intervening gaps between the chunks for purposes of determining a span, midpoint, or alignment reference. In other embodiments, the aggregated spectrum excludes intervening gaps between chunks when considering allocated or usable spectrum resources.

As used herein, an “aggregated bandwidth (BW)” may refer to a total bandwidth associated with a plurality of chunks. In some embodiments, the aggregated BW excludes intervening gaps between the chunks when considering allocated or usable spectrum resources.

In some embodiments, in addition to indicating a maximum number of supported component carriers (CCs) for contiguous intra-band carrier aggregation (CA), or for each sub-block in non-contiguous intra-band CA, a user equipment (UE) may also indicate a maximum aggregated BW. This additional indication may be provided via capability signaling using at least one of a ca-BandwidthClassDL-NR parameter or a ca-BandwidthClassUL-NR parameter.

For a cell configured with non-contiguous spectrum, both a CC-count constraint and a bandwidth constraint may apply. Specifically, a number of configured spectrum chunks in the cell may be counted toward a maximum supported number of CCs, and a total aggregated BW of the chunks may be constrained to not exceed a maximum supported aggregated channel bandwidth indicated by the UE.

In some embodiments, an aggregated BW of a plurality of chunks in a cell with non-contiguous spectrum may be determined based on a sum of bandwidths of the chunks. In some implementations, the aggregated BW may be determined without including frequency gaps between the chunks.

In other embodiments, for purposes of determining an overall span, the frequency gaps between the chunks may be considered as part of an aggregated spectrum, without affecting the aggregated BW. The former approach may be beneficial if the UE treats the cell with non-contiguous spectrum as a large cell with contiguous spectrum, while the latter may be used if the UE treats each chunk separately.

In some embodiments, the UE may indicate to the gNB, via capability signaling, a supported total aggregated BW of a cell with non-contiguous spectrum. This indication may be independent of an indication of the maximum number of CCs for a given band or band combination.

The legacy ca-BandwidthClassDL-NR and ca-BandwidthClassUL-NR parameters may include constraints on a number of CCs and a supported aggregated channel bandwidth. In some embodiments, additional constraints may be applied to NR CA bandwidth classes for a single cell with non-contiguous spectrum. For example, constraints may include a minimum or maximum bandwidth of each chunk, a minimum or maximum frequency gap between any two consecutive chunks, and a maximum or minimum span between a lowest-frequency chunk and a highest-frequency chunk of the non-contiguous spectrum.

In some embodiments, a UE may be configured with a capability to indicate to the gNB, e.g., via capability signaling, a maximum supported number of contiguous CCs and a maximum supported number of non-contiguous CCs. This indication may be realized using any of the approaches described herein for indicating a maximum supported number of intra band non-contiguous CCs, intra band contiguous CCs, and/or inter band non-contiguous CCs. For example, the UE may indicate to the gNB, e.g., via capability signaling, whether chunks of a cell with non-contiguous spectrum should be counted towards the limit on the maximum supported number of contiguous CCs or non-contiguous CCs. Alternatively or additionally, when a UE indicates the maximum number of contiguous CCs and non-contiguous CCs, one or more rules may be applied to determine whether to count the chunks of a cell with non-contiguous spectrum towards the limit of the contiguous CCs or non-contiguous CCs.

In some embodiments, the one or more rule may be any of the following rules, or any combination of rules as follows. If a frequency separation between different chunks is less than a certain threshold, then the chunks of a cell with non-contiguous spectrum may be counted towards the limit on the number of contiguous CCs; otherwise, the limit on the number of non-contiguous CCs is used. The value of the threshold may be indicated by the UE to the gNB via capability signaling. The frequency range, e.g., FR1 or FR2, may determine whether to count the chunks of a cell with non-contiguous spectrum towards limit of the contiguous CCs or non-contiguous CCs. For example, the chunks of a cell with non-contiguous spectrum in FR1 and FR2 are counted towards the limit of contiguous CCs and non-contiguous CCs, respectively.

In some embodiments, when a UE indicates the maximum supported number of contiguous CCs and non-contiguous CCs, some chunks may be grouped and are counted towards one bandwidth class, e.g., number of contiguous CCs, and a remaining set of ungrouped chunks can be treated as non-contiguous CCs and counted towards the limit of the number of non-contiguous CCs.

In some embodiments, to determine how to split the chunks into groups, any of the following alternatives, or various combinations thereof, may be applied. For example, the grouping of chunks may be based on a frequency separation, or frequency gap, between the chunks. The chunks that are close to each other may be counted towards the limit of the number of contiguous CCs. The chunks that are separated with large frequency gaps from the consecutive chunks may be counted towards the limit of the number of non-contiguous CCs. For example, a cell with non-contiguous spectrum may comprise five chunks. The first two chunks are relatively close to each other, and thus they are grouped together counted towards the limit of contiguous CCs. The other three chunks are ungrouped may be counted towards the limit on non-contiguous CCs.

In some embodiments, determining when chunks can be considered close to each other may be based the frequency separation between any two consecutive chunks in the group. The maximum frequency separation between two consecutive chunks to be considered in the same group may be indicated by the UE to the gNB via capability signaling. It may be in terms of RE, RB, KHz, MHz, frequency, or the like, and it may be measured between boundaries of consecutive chunks.

In some embodiments, a plurality of groups of chunks may exist, wherein each group is in a different frequency band. In this case, the chunks within a group may be counted towards the limit of contiguous CCs in the corresponding band. Then the number of groups may be counted towards the limit of non-contiguous CCs. For example, assume a cell with non-contiguous spectrum comprises 6 chunks and each group has two chunks. In this case, for each group, two CCs may be counted towards the number of contiguous CCs limit in the corresponding band. Then three CCs may be counted towards the number of non-contiguous CCs corresponding to the three groups.

In some embodiments, the grouping of chunks may be based on a frequency range (FR) of each chunk within a cell with non-contiguous spectrum. For example, chunks in FR1 may be grouped together and counted towards the limit of contiguous CCs, while the chunks in FR2 may be counted towards the limit of non-contiguous CCs. Although this example counts each chunk in a cell with non-contiguous spectrum towards a certain limit on the number of supported contiguous CCs, or non-contiguous CCs, it should be understood that all chunks within a group may be counted towards B. For example, if a cell with non-contiguous spectrum has 3 chunks, it may be counted as B CCs towards any limit on the number of supported CCs, either contiguous CCs or non-contiguous CCs.

In some embodiments, as yet another possibility to indicate the maximum number of supported chunks, a similar framework used for indicating the supported CA capabilities may be used. For example, the legacy specifications for determining whether CCs are considered contiguous or non-contiguous may be applied relative the chunks of a cell with non-contiguous spectrum.

In some embodiments, for indicating the maximum number of supported contiguous or non-contiguous chunks with a cell, a framework in lieu of or in addition to the one used for CA may be applied. For example, a new capability, such as a BandCombination_chunk parameter, may be introduced which may be in addition to or in lieu of a legacy BandCombination parameter. Nevertheless, the new capability parameter may be interpreted relative the chunks of a cell with non-contiguous spectrum. For example, as part of the BandCombination_chunk parameter, information on the band in which a cell with non-contiguous spectrum is supported may be indicated via a bandList parameter.

Additionally, in some embodiments, the maximum supported number of contiguous chunks within a cell may indicated via a parameter similar to legacy ca-BandwidthClassDL-NR/ca-BandwidthClassUL-NR which may additionally indicate the maximum supported aggregated bandwidth calculated as described earlier. To this end, a legacy BandParameters parameter may be used, but interpreted relative to the chunks instead of the CCs.

In some embodiments, within a new parameter such as BandCombination_chunk, a UE may indicate the maximum supported number of non-contiguous intra-band chunks within a cell with non-contiguous spectrum. For example, the same (i.e., identical) band may be indicated multiple times in BandList to indicate supporting non-contiguous intra-band chunks in a cell with non-contiguous spectrum. The maximum number of chunks may be determined based on how many times the same band is indicated in BandCombination_chunk. For example, if the same band is indicated three times in BandList of BandCombination_chunk, this may mean that maximum three non-contiguous intra-band chunks within the same cell are supported.

In some embodiments, a UE may indicate that it supports a cell with non-contiguous spectrum where its chunks are in different bands, i.e., non-contiguous inter-band chunks. This indication may be provided through the new RRC capability parameter, e.g., BandCombination_chunk, where BandList may indicate the bands in which the chunks of a cell with non-contiguous spectrum may exist. For example, if BandList indicates bands n1 and n4, this may mean that a UE supports a cell with non-contiguous spectrum comprises two chunks. One chunk may be in a band denoted as n1 and another chunk may be in a band denoted as n4. A UE may then expect that a gNB configures a cell with non-contiguous spectrum based on the indicated capabilities. In other words, when configuring a cell with non-contiguous spectrum, the gNB should not exceed the indicated capabilities in terms the maximum aggregated BW across the different chunks, maximum number of intra-band chunks, and maximum number of inter-band chunks.

In some embodiments, the supported capability for transmission or reception in a cell with non-contiguous spectrum may be provided by using the same CA capability framework for indicating both the CA capability and the chunk capability. Pursuant to one example, an RRC IE BandCombination parameter may be interpreted twice. The first interpretation may be based on a legacy CA capability framework, wherein bandList and the RRC IE parameter in BandCombination, may be used to indicate the supported CA properties. For example, bandList can indicate whether inter-band or intra-band CA is supported, and the number of supported CCs.

According to another embodiment, the same indicated parameters described above are interpreted relative to chunks of a cell with non-contiguous spectrum. For example, the bands indicated in bandList may be interpreted as the bands in which the chunks of a cell with non-contiguous spectrum can be configured in. For example, if bandList includes three inter-bands, e.g., n1, n10, and n15, then it means that a UE may support configuring a cell with three chunks, one chunk in each band. Similarly, if the same band is indicated multiple times in bandList, i.e., n1, n1, and n1, this means that the UE supports three non-contiguous chunks in band n1 for serving cell with non-contiguous spectrum, similar to non-contiguous intra-band CA.

In legacy NR, bandList conveys information on the number of supported CCs which translates to the number of serving cells, and each CC may correspond to a serving cell. In some embodiments, when interpreting the BandCombination parameter relative to the chunks, all chunks may be associated with a single serving cell with non-contiguous spectrum. To provide a UE with more flexibility in indicating its capability, the UE may indicate a number of chunks that can be mapped to a single serving cell. To this end, additional RRC parameters may be introduced to indicate the maximum number of chunks that can be mapped to a single serving cell. For example, a parameter such as NumChunkIntra_InterPerCell may indicate the maximum number of chunks per serving cell, regardless of whether these chunks are intra-band or inter-band, as shown in the code block below:

| | |
|---|---|
| BandCombination ::= | SEQUENCE { |
| bandList | SEQUENCE (SIZE (1..maxSimultaneousBands)) OF |

BandParameters,

| | |
|---|---|
| featureSetCombination | FeatureSetCombinationId, |
| ca-ParametersEUTRA | CA- |
| ParametersEUTRA | OPTIONAL, |
| ca-ParametersNR | CA- |
| ParametersNR | OPTIONAL, |
| mrdc-Parameters | MRDC- |
| Parameters | OPTIONAL, |
| supportedBandwidthCombinationSet | BIT STRING (SIZE |
| (1..32)) | OPTIONAL, |
| powerClass-v1530 | ENUMERATED |
| {pc2} | OPTIONAL, |
| NumChunkIntra_InterPerCell | INTEGER (1,... |
| maxSimultaneousCHUNKSs) | OPTIONAL |

Table 6 below shows an example of a set of provided bands in bandList, (n1, n1, n1, n10, n10, and n12), and a maximum number of chunks per serving cell, according to the subject matter disclosed herein. Either these chunks are in the same band, i.e., intra-band chunks, or in different chunks, inter-band chunks. In the example shown in Table 6, one serving cell may comprise three chunks, and the remaining serving cells may comprise a single chunk.

In some embodiments, the following may be considered as valid configurations, as well as any combinations of these configurations:

Serving cell 1 may comprise three chunks in any three bands, e.g., three non-contiguous chunks in band n1; three chunks in distinct chunks, n1, n10, and n12; two non-contiguous chunks in band n1 and one chunk in any other supported bands; one chunk in band n1 and two non-contiguous chunks in band n10, etc., and/or:

Serving cells 2, 3, and 4, wherein each cell may comprise a single chunk such that total number of chunks across all of the serving cells does not exceed 6 chunks.

In some embodiments, more than one of the serving cells may contain more than one of the chunks. The following may be considered as valid configurations, as well as any combinations of these configurations:

Serving cells 1, 2 and 3, wherein each cell has two chunks. For example, serving cell 1 may comprise two non-contiguous intra-band chunks in band n1, serving cell 2 may comprise two inter-band chunks in band n1 and n10, serving cell 3 may comprise two inter-band chunks in band n10 and n12. In another example, Serving cell 1 may have three intra-band chunks in band n1, serving cell 2 may have two intra-band chunks in band n10, and serving cell 3 may have a single chunk in band 12.

TABLE 6
Indicating Maximum Number of Inter-Band Chunks
and Intra-Band Chunks per Serving Cell

| | | | | | | |
|---|---|---|---|---|---|---|
| Indicated band in bandList | n1 | n1 | n1 | n10 | n10 | n12 |

| | |
|---|---|
| NumChunkIntra_InterPerCell | 3 |

In some embodiments, to provide a UE with more flexibility in indicating its capability for supporting a single cell with non-contiguous spectrum, additional RRC parameters may indicate the maximum number of intra-band chunks, e.g., NumChunkIntraPerCell, and/or the maximum number of inter-band chunks, e.g., NumChunkInterPerCell, as shown in the code block below.

| | |
|---|---|
| BandCombination ::= | SEQUENCE { |
| bandList | SEQUENCE (SIZE (1..maxSimultaneousBands)) OF |

BandParameters,

| | |
|---|---|
| featureSetCombination | FeatureSetCombinationId, |
| ca-ParametersEUTRA | CA- |
| ParametersEUTRA | OPTIONAL, |
| ca-ParametersNR | CA- |
| ParametersNR | OPTIONAL, |
| mrdc-Parameters | MRDC- |
| Parameters | OPTIONAL, |
| supportedBandwidthCombinationSet | BIT STRING (SIZE |
| (1..32)) | OPTIONAL, |
| powerClass-v1530 | ENUMERATED |
| {pc2} | OPTIONAL, |
| NumChunkIntra_InterPerCell | INTEGER (1,... |
| maxSimultaneousCHUNKS) | OPTIONAL, |
| NumChunkIntraPerCell | INTEGER (1,... |
| maxSimultaneousCHUNKS) | OPTIONAL, |
| NumChunkInterPerCell | INTEGER (1,... |
| maxSimultaneousCHUNKS) | OPTIONAL |

Though the minimum value of NumChunkIntra_InterPerCell, NumChunkIntraPerCell, and NumChunkInterPerCell is 1, other values may be used as minimum value. For example, the minimum value may be 2. In this case, the absence of this parameter may mean a default value of the number of chunks per serving cell is applied, e.g., 1.

Table 7 below shows an example where a UE indicates the maximum number of inter-band chunks and intra-band chunks per serving cell, maximum number of inter-band chunks only per serving cell, and maximum number of intra-band chunks only per serving cell, according to the subject matter disclosed herein. According to some embodiments, the following are some examples of counting approaches of different chunks towards the corresponding budget: Counting towards NumChunkIntraPerCell: Counting chunks towards this limit may be per band. For example, if a serving cell contains three chunks in band n1 and two chunks in band n10, then NumChunkIntraPerCell may be considered as satisfied if the number of chunks per any band is than or equal 3. Nevertheless, the limit NumChunkIntra_InterPerCell may not be satisfied when total number of chunks per this cell is 5.

In some embodiments, some of the indicated bands may support contiguous chunks, e.g., based in the indicated band class such as B, C, . . . , L. In this case, those contiguous intra-band chunks may be counted as one towards NumChunkIntraPerCell. Alternatively, each one may be counted separately to keep an analogy with how band class is defined in a CA framework. Also, a UE may indicate whether it prefers to count contiguous intra-band chunks as 1 or count the chunks separately towards NumChunkIntraPerCell.

In some embodiments, counting towards NumChunkInterPerCell proceeds as follows. One simple approach is to count a band of the chunks in a cell as one towards this NumChunkInterPerCell limit, regardless of the number of chunks in this band. For example, if a cell comprises three non-contiguous intra-band chunks in band n1 and two non-contiguous intra-band chunks in band n10, then this is counted as two towards NumChunkInterPerCell. That is, there are only two bands, though each band has more than one chunk. Nevertheless, the limit NumChunkIntra_InterPerCell may not be satisfied as the total number of chunks is five, exceeding the value indicated by the UE.

In another embodiment, the chunks within each band are counted towards NumChunkInterPerCell. Referring to the previous example, a cell may comprise three non-contiguous intra-band chunks in band n1 and two non-contiguous intra-band chunks in band n10, and then this may be counted as five towards NumChunkInterPerCell.

As yet another example, when a UE indicates the limit NumChunkInterPerCell, the UE may expect to be configured with a single chunk per band.

TABLE 7
Indicating Maximum Number of Inter-Band Chunks
and Intra-Band Chunks, Inter-Band Chunks Only,
and Intra Band Chunks Only per Serving Cell

| | | | | | | |
|---|---|---|---|---|---|---|
| Indicated band in bandList | n1 | n1 | n1 | n10 | n10 | n12 |

| | |
|---|---|
| NumChunkIntra_InterPerCell | 3 |
| NumChunkIntraPerCell | 3 |
| NumChunkInterPerCell | 2 |

In some embodiments, the aforementioned approach to indicate the maximum number chunks per serving cell may be applied even when the aforementioned separate capability framework is used for indicating the chunk capabilities based on BandCombination_chunk.

In some embodiments, though the aforementioned limits may be defined to per serving cell, the above limits may be absolute independent of how the chunks are divided across the different chunks. For example, NumChunkIntra_InterAbsolute, similar to NumChunkIntra_InterPerCell, may indicate the maximum number of chunks across all bands and across all serving cells. The same may be applied for NumChunkIntraPerCell and NumChunkInterPerCell which may replace NumChunkIntraAbsolute and NumChunkInterAbsolute, respectively. These replacement parameters may indicate a maximum number of intra-band and inter-band chunks across all bands and across all serving cells.

In some embodiments, selecting a budget from among the BWP budget and the CC budget may be determined based on a granularity level of each of these budgets. For example, indicating support for two or four BWP is indicated per band. Therefore, if within a band, a UE is configured with a cell with non-contiguous spectrum in this band, then the BWP budget within this band may be affected. However, the BWP budget for other bands may not be affected by supporting a cell with non-contiguous spectrum. The same may apply for the maximum number of contiguous CCs as it is a per band capability.

In some embodiments, when a UE directly indicates to a gNB the number of supported chunks per BWP, per CC, per cell, per band, per band combination, etc., using separate capability signaling than ones used to indicate the number of supported BWPs/CCs, it may be beneficial to define how these signals interact. In some embodiments, a third signal indicating the maximum supported total number of chunks and BWPs/CCs may be introduced. For example, a UE may indicate that it supports 2 chunks per BWP, supports 2 BWPs, and supports total of 2 chunks and BWPs. This means that gNB can configure with two contiguous BWPs, or one BWP with two non-contiguous chunks. This is beneficial as it provides more flexibility to the gNB.

In some embodiments, though in parts of this disclosure, chunks are defined as BWPs or part of BWP, it should be understood that the BWP concept in these solutions may be replaced with a serving cell concept. For example, in the embodiments in which chunks are described as non-contiguous BWP, it may be understood as a serving cell comprising non-contiguous chunks without using the BWP concept. In one example embodiment, a single serving cell may include a BWP comprising multiple non-contiguous chunks distributed across different frequency bands, such that the chunks are configured and signaled as part of a single serving cell.

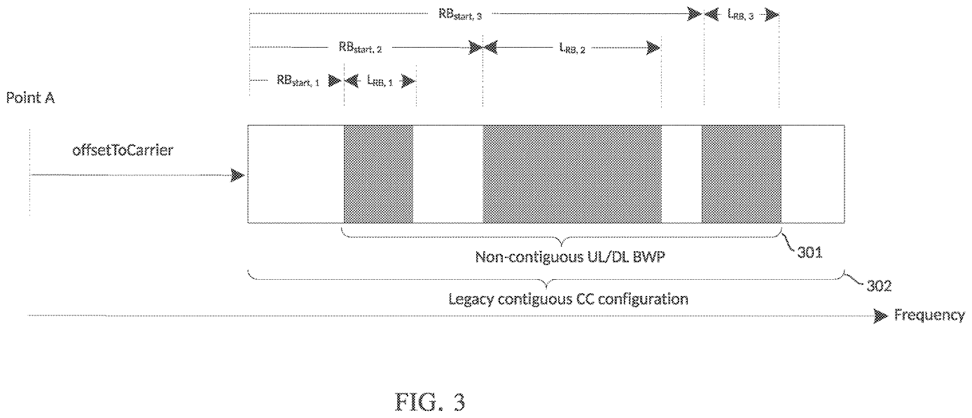

FIG. 3 illustrates an example of a non-contiguous UL/DL BWP 301 in comparison to a legacy contiguous CC configuration 302. The BWP 301 corresponds to shaded portions representing spectrum chunks, while unshaded regions between adjacent chunks represent frequency-domain gaps. The legacy continuous CC configuration 302 may include both the shaded portions and the unshaded regions. As used herein, a “gap” refers to a frequency-domain region between two adjacent spectrum chunks in which no resource blocks (RBs) or resource elements (REs) are allocated as part of the BWP. For example, a gap may correspond to a set of RBs between a highest RB of a first chunk and a lowest RB of a next chunk. Accordingly, the BWP 301 corresponds only to the shaded portions (i.e., the chunks), and does not include the intervening gaps.

In some embodiments, although the BWP 301 includes non-contiguous chunks, an underlying CC may remain configured as a contiguous set of RBs. This may be beneficial because requirements such as spectrum emission masks are defined at the CC level, thereby avoiding introduction of additional requirements on the UE while enabling non-contiguous spectrum operation at the BWP level. In another embodiment, since a UE may be required to transmit/receive within a BWP, regardless the size of the CC containing this BWP, the CC may be configured similar to legacy and comprise contiguous RBs. This may be beneficial as Radio Access Network Working Group 4 (RAN4) requirements, e.g., spectrum emission mask, are based on CC, not the BWP which avoid imposing new requirements on the UE. In this case, the UL/DL BWP may be configured to comprise non-contiguous spectrum.

In some embodiments, frequency-domain location of each chunk may be indicated using RIV-based signaling. For example, multiple LocationAndBandwidth parameters may be used to indicate respective RIV values for each chunk, where each RIV defines a starting RB and a length of the corresponding chunk relative to a carrier reference (e.g., based on offsetToCarrier and a subcarrier spacing).

In some embodiments, separate RIV values may be provided for each chunk. Alternatively, a first chunk may be indicated explicitly, and additional chunks may be defined using offset-based parameters relative to the carrier or relative to previously defined chunks.

In some embodiments, a UE may perform communication using the BWP 301 by transmitting and/or receiving signals over the plurality of non-contiguous chunks, where scheduling across chunks is coordinated such that the chunks collectively function as a unified resource set.

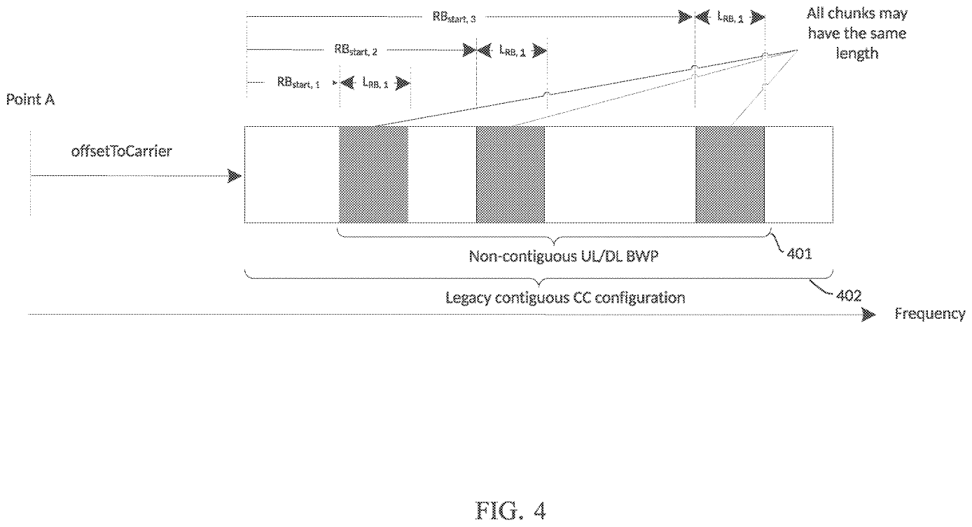

FIG. 4 illustrates an example of a non-contiguous UL/DL BWP 401 in comparison to a legacy contiguous CC configuration 402. The BWP 401 includes multiple spectrum chunks, shown as shaded portions, which in the present example may all have equal sizes. Thus, the shaded portions may represent chunks and the unshaded regions may represent frequency-domain gaps. The legacy continuous CC configuration 402 may include both the shaded portions and the unshaded regions. In some embodiments, the equal-sized chunks may reduce signaling overhead by reducing a number of parameters required to define the BWP relative to configurations in which each chunk is independently defined.

In some embodiments, a first chunk may define a reference bandwidth, and one or more additional chunks may be defined relative to the first chunk using offset-based parameters. For example, a single RIV value may define the first chunk, and additional parameters may indicate offsets to subsequent chunks relative to a carrier reference or relative to previously defined chunks. In another example, a configuration parameter associated with the first chunk may indicate a bandwidth that is applied to other chunks, while additional parameters specify frequency offsets of the remaining chunks. For the remaining chunks, a next generation Node B (gNB) may indicate an offset relative to the beginning of the CC which is provided by offsetToCarrier with the same subcarrier spacing (SCS) configured for the BWP, e.g., via an RRC parameter. Alternatively, the offset may be relative to the lowest/highest RE/RB of chunk that has been indicated via RIV, e.g., via an RRC parameter.

In some embodiments, for time division duplex (TDD) operation, a center frequency of a non-contiguous BWP may be defined based on an aggregated spectrum spanning from a lowest-frequency chunk to a highest-frequency chunk, including intervening gaps. Alignment between UL and DL BWPs may be defined based on such aggregated spectrum, or alternatively based on alignment between corresponding chunks.

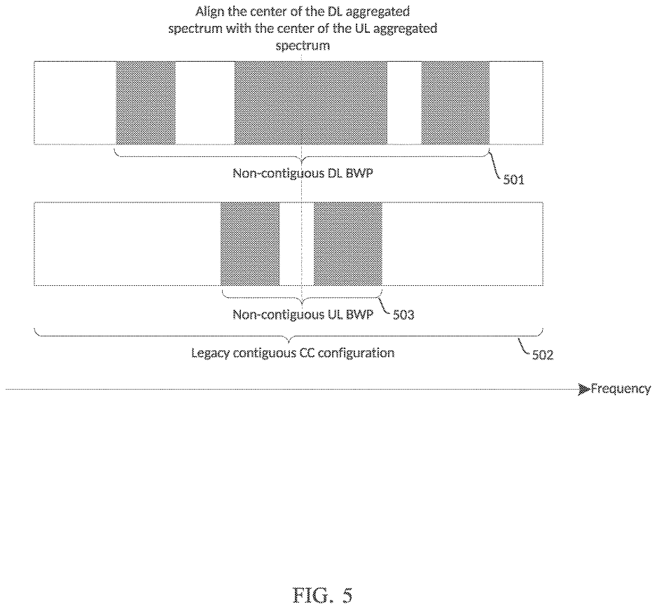

FIGS. 5-7 illustrate example alignment configurations between non-contiguous DL BWPs and non-contiguous UL BWPs, in comparison to legacy contiguous CC configurations, according to the subject matter disclosed herein.

FIG. 5 illustrates an example in which a non-contiguous DL BWP 501 and a non-contiguous UL BWP 503 are aligned based on an aggregated spectrum representation, in comparison to a legacy contiguous CC configuration 502. In some embodiments, each of the DL BWP 501 and the UL BWP 503 includes multiple non-contiguous spectrum chunks that are treated as a single logical BWP. The DL BWP 501 and the UL BWP 503 correspond to shaded portions representing the spectrum chunks, while unshaded regions between adjacent chunks correspond to frequency-domain gaps in which no resource blocks (RBs) or resource elements (REs) are allocated.

As used herein, an “aggregated spectrum” may refer to a frequency-domain span extending from a lowest-frequency edge of a lowest-frequency chunk to a highest-frequency edge of a highest-frequency chunk. In some embodiments, the aggregated spectrum includes intervening gaps between the chunks for purposes of determining a span, midpoint, or alignment reference. In other embodiments, the aggregated spectrum excludes intervening gaps between chunks when considering allocated or usable spectrum resources.

According to the embodiment illustrated in FIG. 5, the “aggregated spectrum” may refer to a frequency-domain span extending from a lowest-frequency edge of a lowest-frequency chunk to a highest-frequency edge of a highest-frequency chunk, including intervening gaps between the chunks. The aggregated spectrum may represent a reference span for alignment or calculation purposes, and does not imply that the intervening gaps are allocated as part of the BWP. In some embodiments, a center frequency of a BWP is defined based on the aggregated spectrum. As shown in FIG. 5, the DL BWP 501 and UL BWP 503 having a same identifier may be configured such that their aggregated center frequencies are aligned, as indicated by vertical alignment reference lines in the figure.

In some embodiments, alignment based on aggregated spectrum may simplify configuration by allowing the DL and UL BWPs to be treated as single logical entities despite being non-contiguous. Such alignment may be beneficial in implementations in which a UE utilizes a common reference frequency or shared local oscillator (LO) across multiple spectrum chunks.

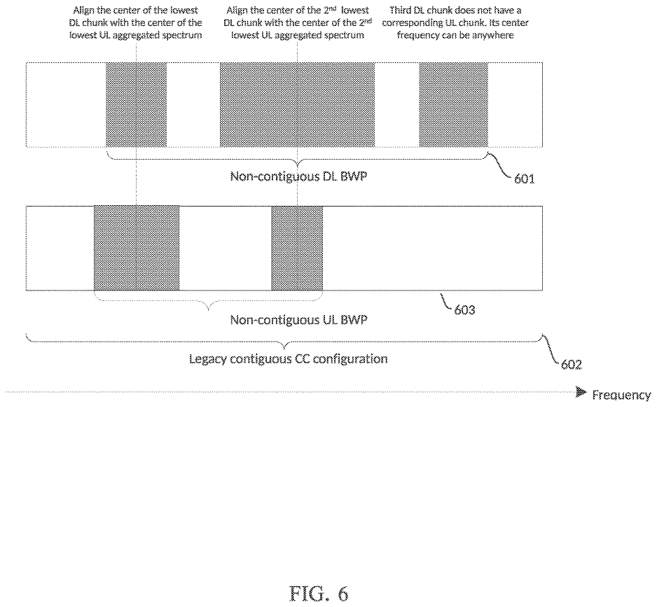

FIG. 6 illustrates an example in which a non-contiguous DL BWP 601 and a non-contiguous UL BWP 603 are aligned on a per-chunk basis, in comparison to a legacy contiguous CC configuration 602. Similar to FIG. 5, shaded portions correspond to spectrum chunks and unshaded regions correspond to frequency-domain gaps.

In some embodiments, alignment between the DL BWP 601 and the UL BWP 603 may be performed on a per-chunk basis. For example, respective DL spectrum chunks and UL spectrum chunks may be pair-wise aligned such that corresponding chunks have aligned center frequencies or aligned boundaries, as indicated by vertical alignment reference lines in the figure. Such pair-wise alignment may enable independent alignment of individual chunks while maintaining a relationship between DL and UL BWPs.

In some embodiments, pair-wise correspondence between DL and UL spectrum chunks may be determined based on ordering of the spectrum chunks. For example, a lowest-frequency DL chunk may correspond to a lowest-frequency UL chunk, a second-lowest DL chunk may correspond to a second-lowest UL chunk, and so on. In some embodiments, pair-wise correspondence may be explicitly configured, for example by associating identifiers with respective DL and UL spectrum chunks and linking chunks having matching identifiers.

In some embodiments, a number of DL spectrum chunks and a number of UL spectrum chunks may differ. In such cases, alignment may be applied to a subset of spectrum chunks, such that each spectrum chunk in one direction is associated with at least one corresponding spectrum chunk in another direction. Alignment constraints may be relaxed for non-overlapping spectrum chunks, such that center frequencies of such chunks are independently configurable.

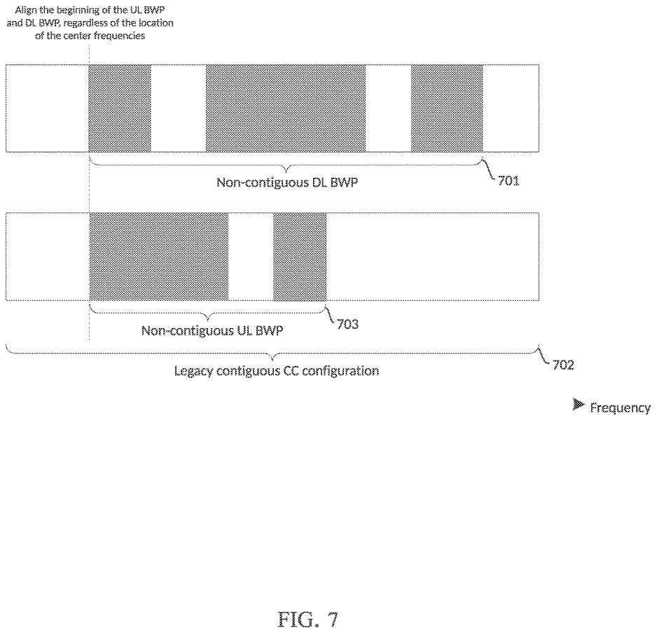

FIG. 7 illustrates an example in which a non-contiguous DL BWP 701 and a non-contiguous UL BWP 703 are aligned based on an edge reference, in comparison to a legacy contiguous CC configuration 702. Similar to FIGS. 5 and 6, shaded portions correspond to spectrum chunks and unshaded regions correspond to frequency-domain gaps.

In some embodiments, alignment between the DL BWP 701 and the UL BWP 703 may be defined based on a boundary of an aggregated spectrum. For example, a lowest-frequency edge of the DL BWP 701 may be aligned with a corresponding lowest-frequency edge of the UL BWP 703, or a highest-frequency edge of the DL BWP 701 may be aligned with a corresponding highest-frequency edge of the UL BWP 703.

In some embodiments, edge-based alignment may simplify configuration by reducing constraints associated with maintaining alignment across multiple non-contiguous spectrum chunks. Such alignment may be applied independently or in combination with other alignment approaches, including aggregated-spectrum-based alignment and per-chunk alignment.

In some embodiments, the alignment approaches illustrated in FIGS. 5-7 provide flexibility in supporting non-contiguous spectrum operation while maintaining coordination between DL and UL transmissions. Selection among alignment approaches may be based on implementation considerations, such as shared LO usage, hardware constraints, scheduling requirements, or UE capability limitations.

In some embodiments, alignment constraints may include limits on an offset between DL and UL BWPs. For example, a UE may support a maximum offset between a center frequency of an aggregated DL BWP and a center frequency of an aggregated UL BWP, or between respective boundaries of the DL and UL BWPs. Such offset constraints may be indicated via capability signaling.

In some embodiments, non-contiguous spectrum support may be asymmetric between DL and UL. For example, a UE may support a non-contiguous DL BWP and a contiguous UL BWP. In such cases, alignment may be applied between an aggregated DL BWP and the UL BWP, or between the UL BWP and a selected DL spectrum chunk.

In some embodiments, a UE may indicate to a gNB a total number of UL/DL BWPs that may comprise non-contiguous spectrum, e.g., via capability signaling. Alternatively or additionally, the UE may indicate a maximum/minimum number of chunks within a UL/DL BWP. The aforementioned capabilities can be applied when UL/DL BWP comprises non-contiguous spectrum, for example, the maximum/minimum spacing between any two chunks, and whether the spacing should be the same between different chunks, the width of the chunks and whether the width of the chunks should be the same.

Operating with a UL/DL BWP comprises non-contiguous spectrum may result in larger power consumption. For example, if a UE may use separate RF front end for each chunk, e.g., separate LO. In this case, it may be beneficial to define fallback option to exclude the chunks that are not actively used.

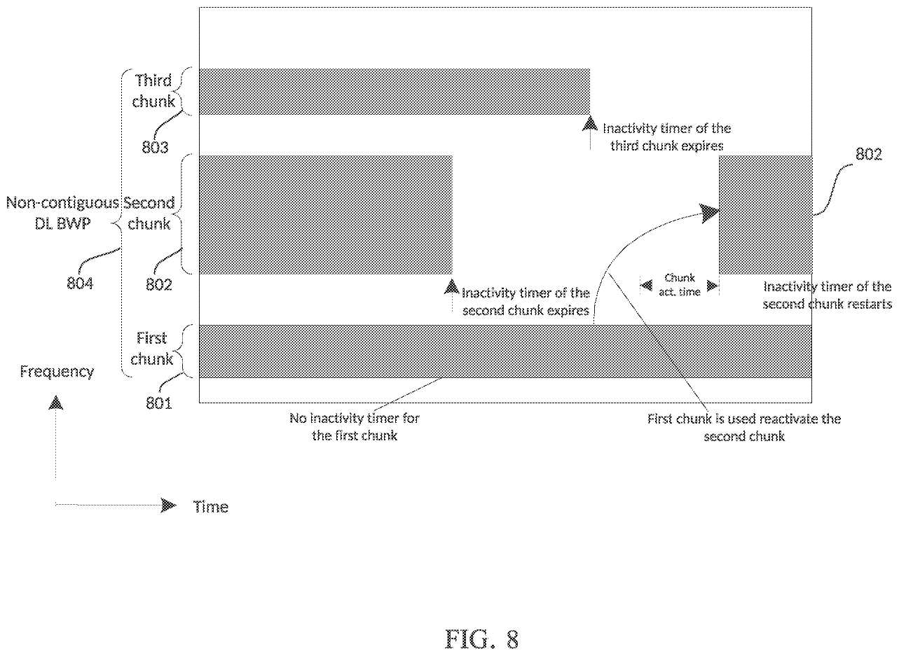

FIG. 8 illustrates an example of a non-contiguous DL BWP 804 including a first chunk 801, a second chunk 802, and a third chunk 803. The chunks 801-803 are separated in the frequency domain and collectively form a single logical BWP 804. Each chunk may correspond to a contiguous set of resource blocks (RBs) within the BWP, and adjacent chunks are separated by frequency-domain gaps in which no RBs are allocated. In some embodiments, respective inactivity timers may be associated with individual chunks of the BWP 804. A chunk-specific inactivity timer may be started, restarted, or maintained based on activity associated with that chunk, such as reception of a DL signal or transmission of an UL signal mapped to the chunk.

In some embodiments, one or more chunks may not be associated with an inactivity timer and may remain active while the BWP 804 is active. For example, a lowest-frequency chunk or a chunk overlapping with an initial BWP may remain active based on predefined rules or configuration.

In some embodiments, when an inactivity timer associated with a chunk expires, the chunk may be considered inactive, and the UE may refrain from transmitting or receiving on that chunk to reduce power consumption. A UE may continue communication on one or more other active chunks of the BWP 804.

In some embodiments, a chunk that has been deactivated may later be reactivated based on control signaling, scheduling information, or traffic conditions. For example, a chunk may be reactivated in response to DL control information received on another active chunk of the BWP 804. In some embodiments, signaling associated with one spectrum chunk may be used to trigger activation, reactivation, or configuration of another spectrum chunk.

In some embodiments, reactivation of a chunk may be associated with an activation time. A UE may not expect to transmit or receive on a reactivated chunk until after the activation time has elapsed. The activation time may be predefined, indicated by the UE via capability signaling, or configured by a network node.

In some embodiments, selection of spectrum chunks that are not associated with an inactivity timer may be based on one or more rules and they may be assumed to active all of the time when the UE using the cell comprising this chunk. For example, a lowest-frequency chunk, a chunk corresponding to a lowest resource block (RB) index, or a chunk overlapping with an initial BWP may remain active while the BWP is active. In some embodiments, a network node may explicitly indicate whether a chunk is associated with an inactivity timer, for example via a flag in RRC signaling.

The value for the inactivity timer may be predefined, e.g., provided in specification, or signaled from the gNB to the UE, via higher layer. It may be the same value applied for all chunks, or separate values applied to different chunks.

In some embodiments, a chunk may be reactivated based on downlink or uplink scheduling associated with another active chunk, including scheduling indicated via downlink control information (DCI). For example, a first chunk may be used to trigger reactivation of a second chunk.

In some embodiments, a UE may not expect to transmit or receive on a reactivated chunk earlier than a defined activation time following a scheduling or triggering signal. For example, a time between an end of reception of a control channel transmission (e.g., a physical downlink control channel (PDCCH)) that schedules a transmission or reception on the reactivated chunk and a corresponding transmission or reception may be greater than or equal to the activation time. The chunk activation time may be predefined, for example, specified in a standard, indicated by the UE to a gNB via capability signaling, or signaled from the gNB to the UE via an RRC parameter.

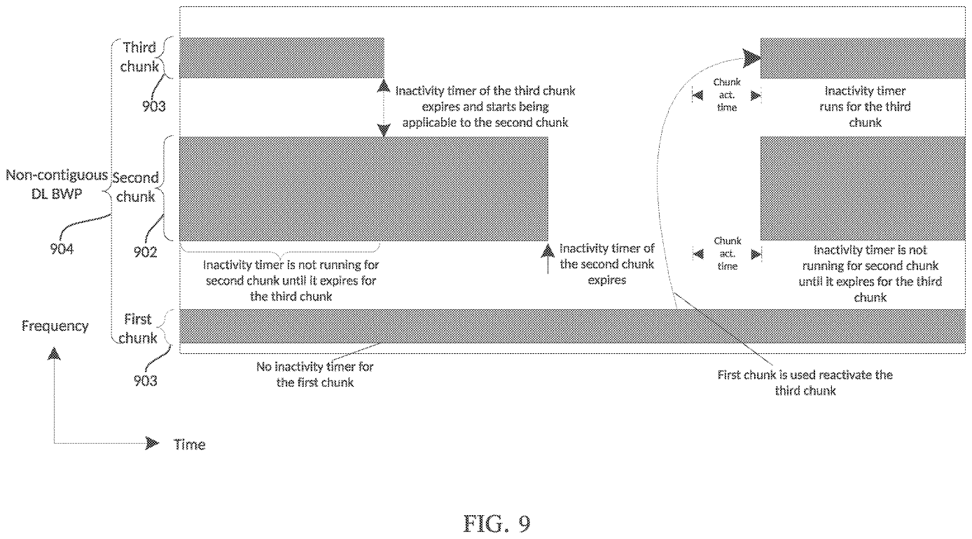

FIG. 9 illustrates an example of a non-contiguous DL BWP 904 in which a single inactivity timer is applied sequentially across multiple chunks. The chunks 901-903 collectively form a single logical BWP 904. In some embodiments, the inactivity timer may be associated with a first chunk (e.g., a highest-frequency chunk) and, upon expiration, may be applied to another chunk. For example, the inactivity timer may initially control the third chunk 903 and, after expiration, may be reassigned to the second chunk 902, while the first chunk 901 remains active. Such a sequential timer approach may reduce implementation complexity relative to maintaining separate inactivity timers for each chunk while still enabling dynamic control of chunk activity within the BWP 904.

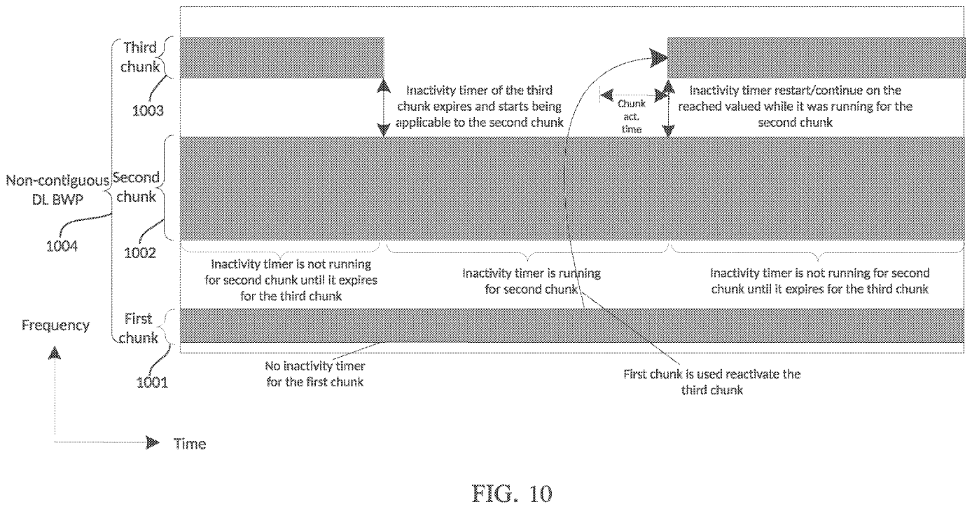

FIG. 10 illustrates an example in which chunk activity is dynamically updated within a non-contiguous DL BWP 1004. In some embodiments, a previously inactive chunk (e.g., the third chunk 1003) may be reactivated while another chunk (e.g., the second chunk 1002) is associated with an inactivity timer. In some embodiments, when a chunk is reactivated, association of the inactivity timer may be updated. For example, the inactivity timer may be reassigned to the reactivated chunk, and the timer may either resume from a current value or be restarted.

In some embodiments, a UE may perform communication over a subset of active chunks while other chunks remain inactive, thereby enabling dynamic adaptation of resource usage and power consumption. Operation over non-contiguous spectrum may introduce additional power consumption considerations. For example, a UE may utilize separate radio frequency (RF) front-end components or local oscillators (LOs) for respective chunks. Selective activation and deactivation of chunks may reduce power consumption associated with such implementations.

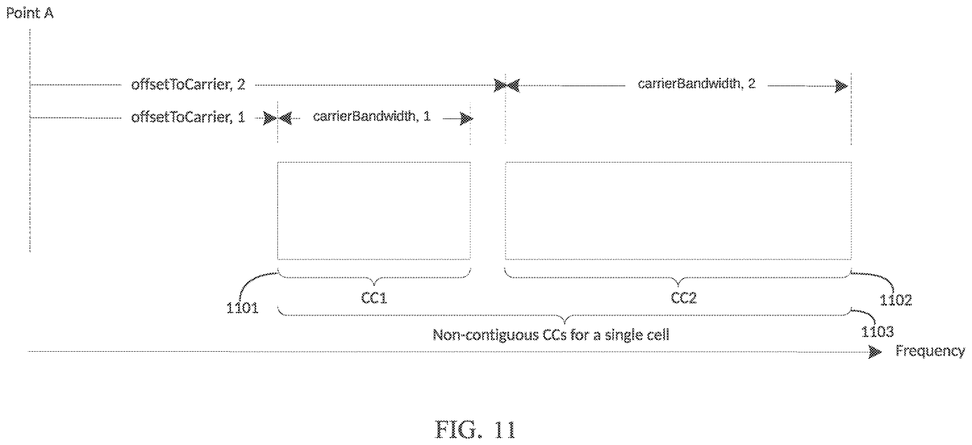

FIG. 11 illustrates an example of configuring non-contiguous spectrum within a single serving cell. In this example, a serving cell 1103 may include multiple component carriers (CCs), such as CC1 1101 and CC2 1102, that are separated in the frequency domain. In some embodiments, the CCs 1101 and 1102 may be associated with a single serving cell 1103 and may be configured to operate as part of a unified cell configuration, rather than being associated with separate serving cells. The start location of each CC is relative to Point A, instead of beginning of CC when non-contiguous chunk treated as a BWP with non-contiguous spectrum.

In some embodiments, a CC may be interpreted as a resource grid associated with a particular subcarrier spacing (SCS), and may be used to define BWPs and other transmission configurations. In such embodiments, multiple CCs corresponding to different frequency regions may be associated with a single serving cell.

In some embodiments, a CC may be interpreted in different ways depending on context. For example, a CC may correspond to an actual carrier to which radio access network (RAN4) requirements are applied, such as spectrum emission constraints. Alternatively, a CC may be interpreted as a resource grid associated with a particular subcarrier spacing (SCS), which is used to define other transmission configurations such as BWPs. Under the resource grid interpretation, multiple CCs corresponding to a same SCS may be used to represent multiple frequency-domain regions (e.g., chunks) within a single serving cell.

In some embodiments, a cell may refer to the configurations for the serving cell which may be provided by RRC IE, e.g., ServingCellConfigCommon, ServingCellConfigCommonSIB, or ServingCellConfig.

In conventional NR, based on configurations provided for a serving cell, characteristics of the cell may be defined. Such characteristics may include, for example, an UL-DL time division duplex (TDD) pattern in case of TDD operation, a frequency-domain location of one or more carriers associated with the cell, and configurations of UL and DL BWPs within the cell. In addition, the characteristics may include a location of a synchronization signal block (SSB), and in the case of a special cell (SpCell), rate matching patterns and other configuration parameters. Separate carriers may be configured for each SCS.

In some embodiments, multiple frequency-domain regions corresponding to a same SCS may be represented using multiple start locations and bandwidths associated with respective chunks, thereby enabling representation of non-contiguous spectrum within a single serving cell while maintaining compatibility with legacy signaling structures.

In some embodiments, configuration of multiple non-contiguous CCs within a single serving cell may reuse or extend legacy RRC signaling structures. For example, parameters such as SCS-SpecificCarrier may be used to indicate frequency-domain location of each CC relative to a reference point (e.g., Point A), including respective offset and bandwidth parameters.

In some embodiments, RRC signaling may include one or more lists of frequency-domain parameters corresponding to multiple chunks or CCs. For example, a configuration may include multiple offset values (e.g., offsetToCarrier) and corresponding bandwidth values (e.g., carrierBandwidth) associated with respective chunks. Such parameters may be conveyed using existing information elements or extensions thereof, including list-based representations, without requiring a specific encoding format.

In some embodiments, legacy RRC signaling structures may be extended to support configuration of multiple frequency-domain regions within a single serving cell. For example, a legacy parameter such as SCS-SpecificCarrier, which in some systems includes a single offset and bandwidth for defining a carrier location, may be modified or extended to include multiple offset values and corresponding bandwidth values associated with respective spectrum chunks. For example, a configuration may include a plurality of offset parameters (e.g., offsetToCarrier values) indicating respective frequency-domain locations of multiple chunks relative to a reference point (e.g., Point A), and a plurality of bandwidth parameters (e.g., carrierBandwidth values) indicating widths of the respective chunks in terms of resource blocks (RBs).

In some embodiments, a single bandwidth value may be applied to multiple chunks when the chunks have equal sizes. In some embodiments, such parameters may be conveyed using a list-based representation or extension of existing information elements, enabling configuration of multiple non-contiguous frequency regions within a unified signaling framework. Such extensions may correspond to standardized encodings (e.g., Abstract Syntax Notation One (ASN.1)-based RRC signaling) or equivalent representations.

In some embodiments, the list-based representation may correspond to extensions of legacy RRC information elements (e.g., SCS-SpecificCarrier) to support multiple frequency locations within a single serving cell. For example, multiple offsets relative to a reference point and corresponding bandwidths may be provided for respective chunks, enabling representation of non-contiguous spectrum allocations within a unified configuration framework.

In some embodiments, the signaling structures described herein may be implemented using standardized encodings (e.g., ASN.1-based RRC signaling) or variations thereof. This implementation is exemplified in Table 8. However, the subject matter disclosed herein is not limited to any particular encoding format, information element structure, or standard release, and may be applied using other signaling mechanisms that convey equivalent configuration information.

TABLE 8
RRC Configurations for Providing Multiple CCs for a Single Cell

-- ASN1START
-- TAG-SCS-SPECIFICCARRIER-START

| | |
|---|---|
| SCS-SpecificCarrier : := | SEQUENCE { |
| offsetToCarrier | INTEGER (0..2199), |
| subcarrierSpacing | SubcarrierSpacing, |
| carrierBandwidth | INTEGER (1..maxNrofPhysicalResourceBlocks), |

```
  ...,
  [[
```

| | |
|---|---|
| txDirectCurrentLocation | INTEGER (0..4095) |

OPTIONAL -- Need S
]]

| | |
|---|---|
| offsetToCarrierList-R20 | SEQUENCE (SIZE (1..maxChunks)) OF offsetToCarrier, |
| carrierBandwidthList-R20 | SEQUENCE (SIZE (1..maxChunks)) OF carrierBandwidth |

}
-- TAG-SCS-SPECIFICCARRIER-STOP
-- ASN1STOP

In some embodiments, a network node may provide configuration information indicating separate frequency locations and bandwidths for multiple CCs associated with a single serving cell. A UE may perform communication across the CCs while treating them as part of a unified serving cell, thereby enabling operation over non-contiguous spectrum while maintaining compatibility with existing signaling frameworks.

In some embodiments, a network node (e.g., a gNB) may configure the serving cell to include the plurality of CCs 1101 and 1102 using shared configuration parameters and coordinated control signaling. A UE may perform communication across the CCs 1101 and 1102 while treating them as part of a single serving cell. Such a configuration may reduce signaling overhead and simplify scheduling relative to approaches in which each CC is treated as a separate serving cell.

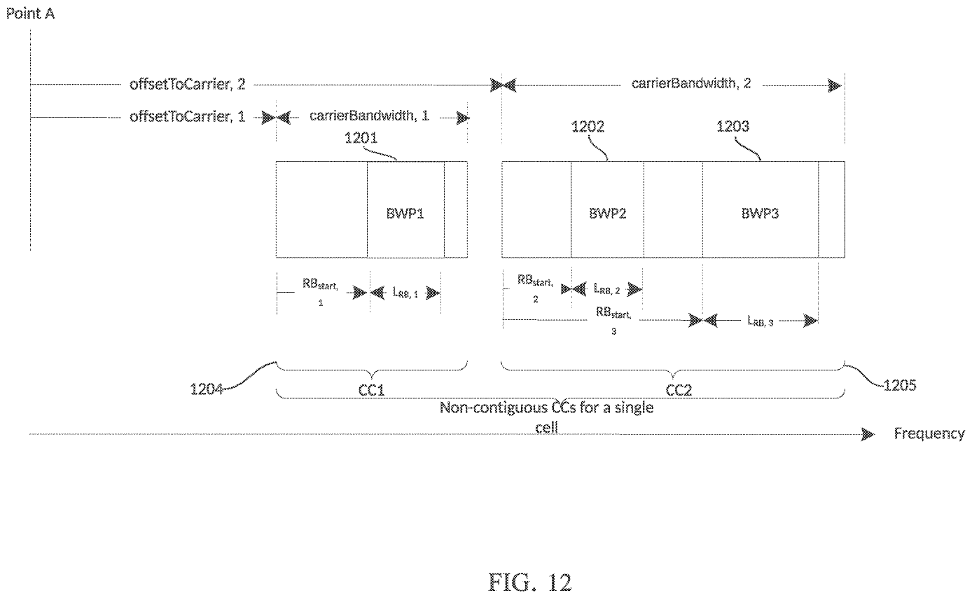

FIG. 12 illustrates an example of configuring BWPs within multiple CCs of a single serving cell according to the subject matter disclosed herein. As shown, the serving cell may include multiple CCs, such as a CC1 1204 and a CC2 1205, and each CC may include one or more BWPs. In some embodiments, the BWP1 1201, the BWP2 1202, and the BWP3 1203 may be configured across different CCs, such as CC1 1204 and CC2 1205, while remaining associated with the same serving cell. For example, the CC1 1204 may include a BWP1 1201, and the CC2 1205 may include a BWP2 1202 and a BWP3 1203. The BWP1 1201, the BWP2 1202, and the BWP3 1203 may be activated or deactivated independently of one another, and may be used for communication in a coordinated manner. In some embodiments, a UE may perform communication using one or more BWPs across the CC1 1204 and the CC2 1205, and scheduling may be coordinated across the BWPs to enable efficient use of non-contiguous spectrum. Such configurations may provide additional flexibility relative to legacy systems by enabling multiple BWPs across multiple CCs within a single serving cell.

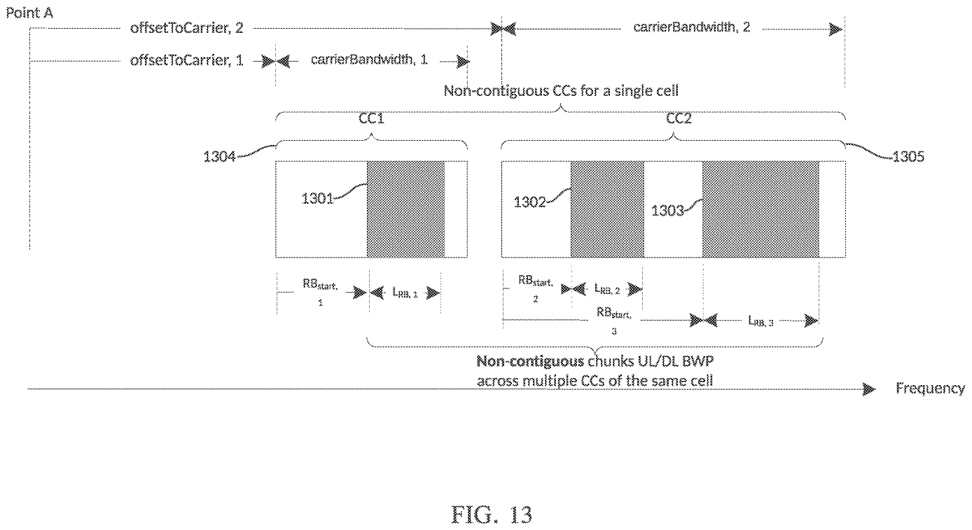

FIG. 13 illustrates configuring a non-contiguous BWP across multiple CCs of a single serving cell, according to the subject matter disclosed herein. Specifically, FIG. 13 shows an example of a cell including two CCs, CC1 1304 and CC2 1305. A single non-contiguous BWP comprises three spectrum chunks, where a first spectrum chunk 1301 is associated with CC1 1304, and a second spectrum chunk 1302 and a third spectrum chunk 1303 are associated with CC2 1305. In this case, an RIV of the first spectrum chunk 1301 may be interpreted relative to CC1 1304, for example based on a corresponding offsetToCarrier parameter. The RIVs of the second and third spectrum chunks 1302, 1303 may be interpreted relative to CC2 1305. In this manner, the plurality of spectrum chunks are configured within the single serving cell while being distributed across multiple CCs.

In some embodiments, frequency-domain parameters of all spectrum chunks of a BWP may be interpreted relative to a single CC selected from among multiple CCs of the serving cell. For example, a network node may indicate the CC to be used, or the CC may be determined based on one or more rules, such as selecting a CC with a lowest index or a lowest center frequency.

In some embodiments, control mechanisms associated with non-contiguous spectrum chunks, including inactivity timers and alignment constraints between DL and UL BWPs, may be applied in response to spectrum chunks of a BWP spanning multiple CCs.

In some embodiments, the single serving cell may be associated with multiple CCs. For example, each non-contiguous spectrum chunk may be represented as a respective CC within the serving cell, and a frequency-domain location of each CC may be defined relative to a reference point.

In some embodiments, configuration of BWPs may be performed in association with the plurality of CCs. For example, a BWP may be linked to a particular CC, and a frequency-domain location of the BWP may be determined relative to the linked CC. In some embodiments, an identifier associated with a CC may be used to establish the linkage between the BWP and the CC. In some embodiments, the linkage may be determined based on one or more rules.

In some embodiments, an identifier (ID) for each CC within a cell may be provided. The ID may be a new RRC parameter, e.g., CC_ID, and it may be part of SCS-SpecificCarrier. Configured BWP may be linked to one CC out of multiple CCs within the cell. For example, the ID of the linked CC, e.g., CC_ID, may be included as part of the BWP configuration. Alternatively, some rules may be used to link BWP ID with CC_ID. For example, BWP ID and CC_ID that have the same value are linked together, or based on an ascending order of BWP ID and CC_ID. In this case, the frequency domain location of BWP will be determined relative to the linked CC.

In some embodiments, a plurality of BWPs may be configured across multiple CCs within a single serving cell. For example, respective BWPs may be associated with different CCs, and frequency-domain parameters of each BWP may be interpreted relative to the corresponding CC.

In some embodiments, configuration constraints associated with BWPs may be applied per CC, across multiple CCs, or based on capability signaling. For example, a maximum number of BWPs may be defined per CC, across CCs within a cell, or indicated via capability signaling.

In some embodiments, a UE may indicate to a gNB a maximum of number of CCs within a cell. Note that, in legacy, a gNB may configure up to four BWP within a cell. This budget may be clarified in response to the cell consisting of multiple CCs. In some embodiments, a BWP budget is applied to each CC within a cell separately, e.g., if a cell comprises two CCs and the legacy budget of BWP per cell is 4, then each CC may be configured with up to 4 BWPs. Alternatively, the indicated BWP budget per cell may be applied on the summation of BWPs in each CC of the cell. For example, if a cell comprises two CCs and the legacy budget of BWP per cell is 4, then total number of BWPs across both CCs may be less than or equal to 4 BWPs. As yet another possibility, the UE may separately indicate the number of supported BWP per CC or across CCs in response to a single cell comprising multiple CCs without affecting legacy capability, and in response to a cell comprising a single CC per SCS. Additionally, a UE may indicate to a gNB whether it supports to have multiple active UL/DL BWPs within different CCs of the same cell. If supported, the UE may also indicate the maximum number of simultaneous active BWPs within different CCs. The UE may still expect to have only one active BWP within a CC.

In some embodiments, the BWP IDs may be unique across a cell with multiple CCs regardless of the CC to which they belong. In other words, the same BWP ID may not be used for any two configured BWPs in the cell regardless of whether or not they are in the same or different CCs within the cell. For example, some or all of the NR configurations may depend on BWP ID. Here are examples from a channel state information (CSI) framework. The CSI framework is a set of mechanisms by which a UE measures radio channel conditions and reports them to the network (gNB) so that the network can make scheduling, link adaptation, and beamforming decisions. For example: CSI-ResoruceConfig IE indicates which BWP in the cell is to carry CSI-RS. For CSI report on PUCCH, either P CSI reporting or SP CSI reporting, the BWP to carry the report is configured in CSI-ReportConfig. For AP CSI reporting, the BWP depends on the DCI triggering PUSCH to carry the report. Therefore, having unique BWP IDs across CCs of a single cell avoid any ambiguity and allow inheriting legacy NR configurations as much as possible. Also, it may be possible to increase the number of supported BWPs per cell. Legacy capability for indicating the maximum supported number of BWPs is per band. Therefore, if a cell comprises multiple CCs, then the number of supported BWPs may be scaled, e.g., based on the number of carriers per cell. For example, if a UE indicates that it supports two BWPs per band and a cell comprises three CCs, then the number of supported BWPs for this cell is six BWPs. Alternatively, a UE may separately indicate the number of supported BWPs in each CCs of a cell with multiple CCs.

As yet another example, Physical Downlink Shared Channel PDSCH-servingCellConfig IE includes the RRC parameter Physical Uplink Control Channel pucch-Cell to indicate which cell to be used for PUCCH transmission carrying HARQ feedback. The PUCCH resource to be used for transmission HARQ feedback depends on the active UL BWP in the cell indicated via pucch-cell. If there is only a single active BWP for a cell that has multiple CCs, then legacy framework can be used to determine the PUCCH to carry the HARQ feedback. However, there may be multiple active UL BWPs within the cell, e.g., one active UL BWP per CC. In this case, some rules may be needed to determine which active UL BWP to be used to carry the HARQ feedback.

In some embodiments, the CC_ID may be used in addition to pucch-Cell to determine the active UL BWP to carry the HARQ feedback to be in which CC of the cell. Alternatively, some rules may be used to determine which CC out of the CCs within the single cell to be used. For example, the CC with the lowest ID, or the one with the lowest center frequency is used. In this case, the UE uses the active UL BWP within this CC to derive the PUCCH to carry the HARQ feedback.

In some embodiments, handling beam failure of a secondary cell (Scell) is another example of dependency of servCellIndex. Specifically, the RRC parameter servingCellId in BeamFailureRecoverySCellConfig IE may be used to indicate the serving cell in which candidate beam Reference Signals (RSs) can be found. Similar to PUCCH-Cell to carry the HARQ, if there is only a single active BWP for a cell that has multiple CCs, then a legacy or existing framework can be used to determine the active BWP to measure RSs for candidate beam identification for the SCell. However, there may be multiple active DL BWPs within the cell, e.g., one active DL BWP per CC. In this case, according to some embodiments, one or more rules may be used to determine which active DL BWP to be used to measure RSs for candidate beam identification for the SCell.

In some embodiments, the CC_ID may be used in addition to servingCellId to determine the active DL BWP to be in which CC of the cell to carry the RSs for candidate beam identification for the SCell. Alternatively or additionally, one or more rules may be implemented to determine which CC out of a set of two or more CCs within the single cell are to be used. For example, a CC with a lowest ID, or A CC with a lowest center frequency is used. In this case, the UE may use an active DL BWP within this CC to measure RSs for candidate beam identification for the SCell. Therefore, in general, when a BWP ID is explicitly configured/indicated for a certain feature, it may be preferred to have a unique BWP ID across CCs with a cell to simplify the corresponding identification.

In some embodiments, in response to only a serving cell ID being provided/determined and the BWP ID being implicitly determined based on the active BWP in this cell, if there is only a single active BWP for a cell that has multiple CCs, then an existing or legacy framework can be used to determine the active BWP. However, in some embodiments, there may be multiple active DL BWPs within the cell, e.g., one active DL BWP per CC. In the case of multiple active DL BWPs within the cell, one or more rules, as the aforementioned ones, may be used to determine which CC among multiple CCs of a single cell may be used to determine the active BWP.

In some embodiments, the legacy BWP switching approaches may be applied across BWPs within the same CC in the case of a cell with multiple CCs. Specifically, each BWP may have its own BWP inactivity timer. Upon the expiry of its timer, it switches to the default/initial BWP within the same CC. In legacy or existing NR, a single default BWP may be defined for a cell, via RRC parameter defaultDownlinkBWP-Id in ServingCellConfig IE. To provide more flexibility, multiple default BWPs may be configured for a cell with multiple CCs. For example, for each CC, the gNB configures the corresponding default BWP. If only a single default BWP is configured, it may belong to one CCs with the cell. The gNB may explicitly configure this CC by providing its CC_id. Alternatively, the CC may be determined implicitly based on some rules. For example, the CC with the smallest Id or with lowest center frequency is used for a single configure default BWP.

In some embodiments, a UE may support multiple active BWPs across different CCs or the same CC within a single serving cell. In such cases, transmission and reception across the multiple CCs may be performed in a manner similar to CA, while remaining associated with the single serving cell.

In some embodiments, a single cell comprising a single CC or multiple CCs based on non-contiguous chunks within the same BWP may be extended, such that the cell is configured to comprise multiple concurrent active BWPs in the same CC.

In some embodiments, BWPs may be grouped, and a UE may operate using one or more groups of BWPs. Within a group, multiple BWPs may be active simultaneously. In some embodiments, a UE may support a maximum number of active BWPs within a group or a maximum number of groups. The UE may indicate how many groups it can be configured with, but only a single group of BWPs can be active concurrently. Also, more capable UEs may support multiple active groups at the same time, subject to capability indication.

In some embodiments, capability signaling may indicate whether multiple active BWPs are supported, whether BWPs within a group are associated with a same band or different bands, and a number of supported groups.

In some embodiments, operation of multiple active BWPs may be associated with constraints on bandwidth, frequency span, or alignment between DL and UL BWPs. For example, alignment constraints associated with non-contiguous spectrum chunks may be applied to groups of BWPs. For example, the center of the group of active DL BWPs may be aligned with center of the group of active UL BWPs. The union of the aggregated DL BWP (including the in-between gaps) and the aggregated UL BWP (including the in-between gaps) may be within UE capability.

In some embodiments, control mechanisms associated with BWPs, including inactivity timers or activation procedures, may be applied to groups of BWPs. In some embodiments, selection of a BWP for a given operation may be determined based on configuration, capability signaling, or one or more rules. Within a group of BWPs, single or multiple inactivity timers similar to the aforementioned timers for a BWP with non-contiguous chunk may be applied for BWPs within the group of BWPs. A UE may indicate whether a group of active BWP is applicable to DL reception only, or UL transmission only or both. Moreover, for determination of the active BWP to be used particular feature, e.g., transmitting HARQ in pucch-Cell, a solution for determining CC_id may be used. For example, BWP_id may be signaled in addition to cell Id to carry the HARQ. Alternatively, some rules may be applied to implicitly determine the applicable BWP, e.g., the active BWP with the lowest Id. When a UE supports multiple active BWPs within a cell, the maximum number of the supported configured BWPs may be indicated via capability signaling to the gNB. This number may differ from a case of a single active BWP being supported in a cell.

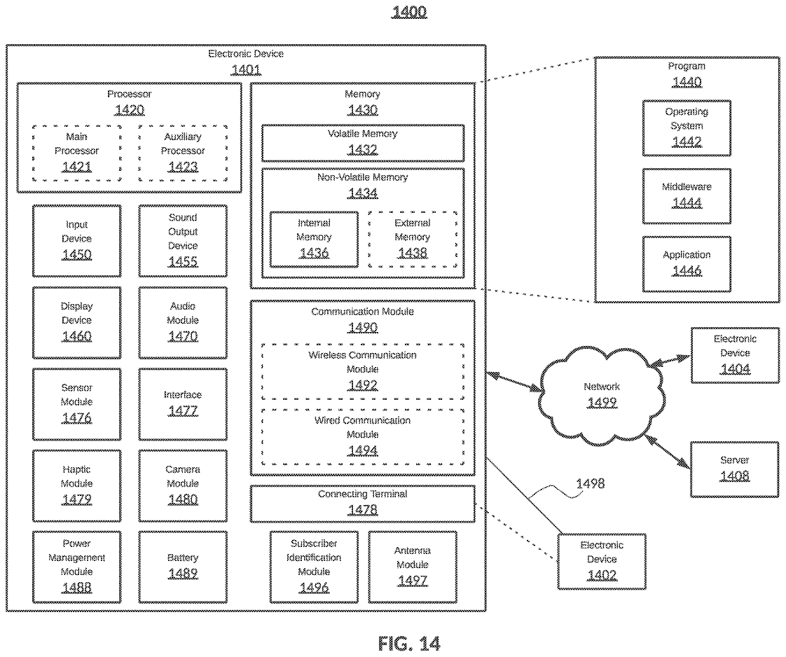

FIG. 14 is a block diagram of an electronic device 1401 in a network environment 1400, according to an embodiment. The electronic device 1401 may communicate with an electronic device 1402 via a first network 1498 (e.g., a short-range wireless communication network), or with an electronic device 1404 or a server 1408 via a second network 1499 (e.g., a long-range wireless communication network). The electronic device 1401 may communicate with the electronic device 1404 via the server 1408.

The electronic device 1401 may include a processor 1420, a memory 1430, an input device 1450, a sound output device 1455, a display device 1460, an audio module 1470, a sensor module 1476, an interface 1477, a haptic module 1479, a camera module 1480, a power management module 1488, a battery 1489, a communication module 1490, a subscriber identification module (SIM) 1496, and an antenna module 1497.

In some embodiments, at least one of the components may be omitted or additional components may be included. Some components may be implemented as an IC.

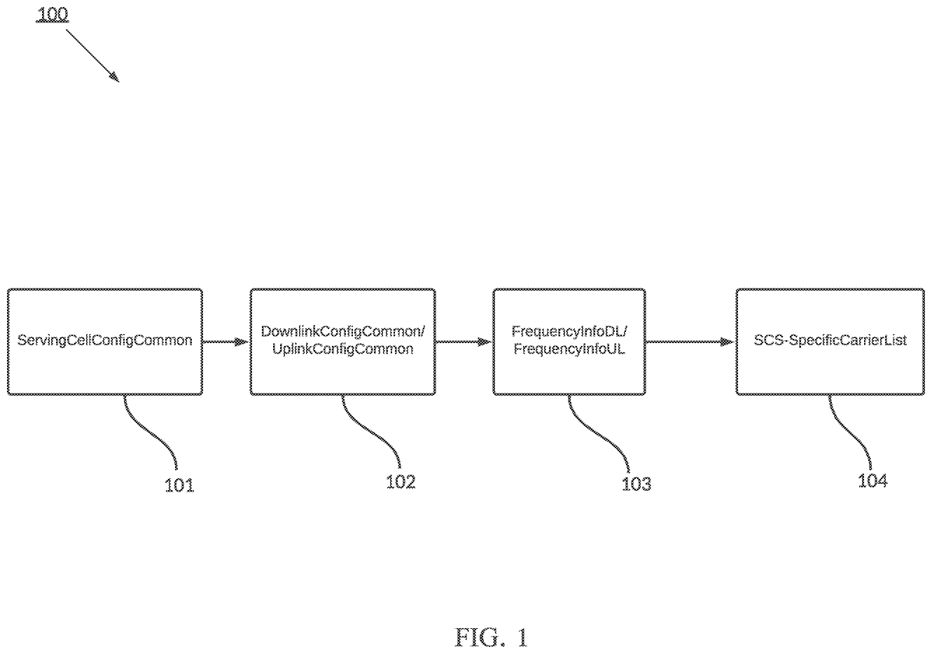

In some embodiments, the electronic device 1401 may be configured to implement one or more of the techniques described with respect to FIGS. 1-13. For example, the processor 1420 may execute instructions to configure a serving cell including a plurality of non-contiguous spectrum chunks, configure a BWP including the plurality of non-contiguous spectrum chunks, and perform communication using the BWP.

In some embodiments, the processor 1420 may control activation or deactivation of one or more spectrum chunks based on control mechanisms such as inactivity timers. The processor 1420 may further control alignment between DL and UL BWPs, including alignment based on aggregated spectrum, per-chunk alignment, or edge-based alignment.

The processor 1420 may include a main processor 1421 and an auxiliary processor 1423, such as a digital signal processor (DSP), neural processing unit (NPU), or communication processor. The auxiliary processor 1423 may perform baseband processing for transmission and reception over non-contiguous spectrum chunks.

The memory 1430 may store configuration parameters associated with non-contiguous spectrum operation, including parameters defining chunk locations, BWP configurations, capability signaling information, and timer-related control parameters.

The communication module 1490 may support establishing communication channels and performing transmission and reception over one or more non-contiguous spectrum chunks associated with a serving cell and/or a BWP. The communication module 1490 may include a wireless communication module 1492 and/or a wired communication module 1494.

The antenna module 1497 may transmit or receive signals via one or more antennas. In some embodiments, different antennas or antenna configurations may be used for different spectrum chunks or frequency ranges.

In some embodiments, configuration and coordination associated with non-contiguous spectrum operation may be at least partially managed by the server 1408.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a user equipment (UE), the method comprising:
transmitting, to a base station, capability information indicating support for non-contiguous spectrum within a serving cell;
receiving, from the base station and based on the capability information, configuration information defining a bandwidth part (BWP) within the serving cell, the BWP including a plurality of non-contiguous spectrum chunks defined by respective frequency-domain parameters; and
performing communication over the plurality of non-contiguous spectrum chunks as part of the BWP.

2. The method of claim 1, wherein the capability information comprises capability signaling defined for carrier aggregation (CA) that indicates support for the plurality of non-contiguous spectrum chunks within the serving cell.

3. The method of claim 2, wherein the capability signaling includes a band combination parameter or repeated indications of a same frequency band corresponding to the plurality of non-contiguous spectrum chunks.

4. The method of claim 1, wherein the configuration information indicates a frequency-domain location of each of the plurality of non-contiguous spectrum chunks using respective frequency-domain parameters.

5. The method of claim 1, wherein the plurality of non-contiguous spectrum chunks have different bandwidths or frequency spacings, or have equal bandwidths defined using a common bandwidth parameter and respective offset parameters.

6. The method of claim 1, wherein the plurality of non-contiguous spectrum chunks correspond to respective component carriers (CCs) associated with the serving cell, or correspond to multiple frequency-domain regions defined within a single resource grid associated with the serving cell.

7. The method of claim 1, further comprising controlling activation or deactivation of at least one of the plurality of non-contiguous spectrum chunks based on at least one timer,
wherein the at least one timer is applied independently to respective spectrum chunks or sequentially across the plurality of spectrum chunks, and
wherein a first spectrum chunk is reactivated based on signaling associated with another spectrum chunk.

8. The method of claim 1, wherein performing communication comprises aligning a downlink (DL) BWP and an uplink (UL) BWP based on:
an aggregated spectrum associated with the plurality of non-contiguous spectrum chunks,
an alignment of respective spectrum chunks, or
an alignment of one or more boundaries of the DL BWP and the UL BWP.

9. The method of claim 1, wherein the capability information includes parameters indicating at least one of:
a number of supported spectrum chunks,
a frequency span,
a size of each spectrum chunk, or
a spacing between spectrum chunks.

10. A user equipment (UE) comprising:
a communication module; and
a processor,
wherein the processor is configured to:
transmit, to a base station, capability information indicating support for non-contiguous spectrum within a serving cell;
receive, from the base station and based on the capability information, configuration information defining a bandwidth part (BWP) within the serving cell, the BWP including a plurality of non-contiguous spectrum chunks defined by respective frequency-domain parameters; and
perform communication over the plurality of non-contiguous spectrum chunks as part of the BWP.

11. The UE of claim 10, wherein the capability information comprises capability signaling defined for carrier aggregation (CA).

12. The UE of claim 10, wherein the processor is configured to control activation or deactivation of at least one of the plurality of non-contiguous spectrum chunks based on at least one timer.

13. The UE of claim 12, wherein the processor is configured to apply the at least one timer independently to respective spectrum chunks or sequentially across the plurality of spectrum chunks.

14. The UE of claim 10, wherein the processor is configured to align a downlink (DL) BWP and an uplink (UL) BWP based on an aggregated spectrum associated with the plurality of non-contiguous spectrum chunks.

15. The UE of claim 10, wherein the processor is further configured to execute instructions stored on a non-transitory computer-readable medium to:
transmit, to the base station, the capability information indicating support for operation over non-contiguous spectrum within the serving cell;
receive, from the base station and based on the capability information, the configuration information defining the BWP within the serving cell including the plurality of non-contiguous spectrum chunks defined by the respective frequency-domain parameters; and
perform communication over the plurality of non-contiguous spectrum chunks as part of the BWP.

16. The UE of claim 15, wherein the processor is further configured to control activation or deactivation of at least one of the plurality of non-contiguous spectrum chunks based on at least one timer.

17. A base station comprising:
a communication module; and
a processor,
wherein the processor is configured to:
receive, from a user equipment (UE), capability information indicating support for operation over non-contiguous spectrum within a serving cell;
transmit, to the UE and based on the capability information, configuration information defining a bandwidth part (BWP) within the serving cell, the BWP including a plurality of non-contiguous spectrum chunks defined by respective frequency-domain parameters; and
coordinate communication over the plurality of non-contiguous spectrum chunks.

18. The base station of claim 17, wherein the configuration information comprises capability signaling defined for carrier aggregation (CA).

19. The base station of claim 17, wherein the processor is configured to define the plurality of non-contiguous spectrum chunks using respective frequency-domain parameters indicating frequency-domain locations and bandwidths.

20. The base station of claim 17, wherein the processor is configured to control activation or deactivation of at least one of the plurality of non-contiguous spectrum chunks based on at least one timer.
